(19) United States
(12) Patent Application Publication
(10) Pub. No.: US 2019/0147124 A1
(43) Pub. Date: May 16, 2019

(54) OPERATION MODEL GENERATOR AND OPERATION MODEL GENERATION METHOD

(71) Applicant: FUJITSU LIMITED, Kawasaki-shi (JP)

(72) Inventors: Akitsugu NAKAYAMA, Fukuoka (JP); Takashi Ishikawa, Fukuoka (JP); Koichi Shirakawa, Kasuya (JP); Noritoshi Yamakawa, Ogori (JP)

(73) Assignee: FUJITSU LIMITED, Kawasaki-shi (JP)

(21) Appl. No.: 16/182,653

(22) Filed: Nov. 7, 2018

(30) Foreign Application Priority Data
Nov. 10, 2017 (JP) 2017-217358

(51) Int. Cl. G06F 17/50; G06F 9/30

(52) U.S. Cl. CPC G06F 17/5009; G06F 9/30101

(57) ABSTRACT

An operation model generator includes one or more memories, and one or more processors configured to perform acquisition of signal information indicating signal values of an input signal and an output signal in a first register transfer level operation model of a logic circuit, and generate a hardware description language operation model of the logic circuit in accordance with the acquired signal information.

### CROSS-REFERENCE TO RELATED APPLICATION

This application is based upon and claims the benefit of priority of the prior Japanese Patent Application No. 2017-217358, filed on Nov. 10, 2017, the entire contents of which are incorporated herein by reference.

### FIELD

The embodiments discussed herein are related to an operation model generation technology.

### BACKGROUND

There has been known an emulation circuit generator that generates data to execute emulation based on simulation data of a digital LSI circuit. A library has a conversion rule to convert information for simulation into information suitable for a hardware emulator. Emulation data generation means inputs simulation data and a simulation result obtained by a logical simulator, and generates emulation data by performing conversion based on the conversion rule in the library. The simulation data is data inputted to the logical simulator, including at least one of test bench information, circuit information, memory pattern information, memory model information, and external device information, and

There has also been known a circuit simulation apparatus that verifies an LSI circuit including a plurality of blocks. Non-verifiable block information retrieval means extracts non-verifiable block information by inputting test bench information having the non-verifiable block information previously described therein. Dummy module generation means generates dummy module information obtained by deleting a circuit function description from the non-verifiable block information. Circuit configuration update means generates resource-saving simulation circuit information by replacing the description of non-verifiable blocks in circuit information describing information of the LSI circuit with the description of the dummy module information. Verification means verifies the LSI circuit by using the resource-saving simulation circuit information.

Related techniques are disclosed in, for example, Japanese Laid-open Patent Publication Nos. 2001-265846 and 2006-185202.

### SUMMARY

According to an aspect of the embodiments, an operation model generator includes one or more memories, and one or more processors configured to perform acquisition of signal information indicating signal values of an input signal and an output signal in a first register transfer level operation model of a logic circuit, and generate a hardware description language operation model of the logic circuit in accordance with the acquired signal information.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1A is a diagram illustrating a hardware configuration example of an information processor according to a first embodiment;

FIG. 1B is a flowchart illustrating an information processing method for the information processor;

FIG. 2 is a diagram illustrating programs and data in the information processor;

FIG. 3 is a diagram illustrating an example of waveform information;

FIG. 4A is a diagram illustrating an example of the terminal information;

FIG. 4B is a diagram illustrating an example of a terminal table;

FIG. 5A is a diagram illustrating an example of a part of the waveform information;

FIG. 5B is a diagram illustrating an example of another part of the waveform information;

FIG. 5C is a diagram illustrating an example of a database;

FIG. 6 is a diagram illustrating an example of the HDL operation model;

FIG. 7 is a flowchart illustrating a processing example of the waveform-model conversion unit;

FIG. 8A is a diagram illustrating an example of a part of waveform information;

FIG. 8B is a diagram illustrating an example of a database;

FIG. 9 is a diagram illustrating an example of the HDL operation model;

FIG. 10 is a flowchart illustrating a processing example of the waveform-model conversion unit;

FIG. 11 is a diagram illustrating an example of a database;

FIG. 12 is a diagram illustrating an example of the HDL operation model;

FIG. 13A and 13B are flowcharts illustrating a processing example of the waveform-model conversion unit;

FIG. 14 is a diagram illustrating programs and data in an information processor;

FIG. 15 is a diagram illustrating an example of an FPGA RTL operation model;

FIG. 16A and 16B are flowcharts illustrating a processing example of the waveform-model conversion unit;

FIG. 17 is a diagram illustrating an example of a database and memory information;

FIG. 18A is a conceptual diagram illustrating a ROM that stores the memory information;

FIG. 18B is a diagram illustrating an example of an FPGA RTL operation model that instances the ROM;

FIG. 19 is a diagram illustrating an example of an HDL operation model that instances a ROM; and

FIG. 20 is a flowchart illustrating an information processing method for an information processor.

### DESCRIPTION OF EMBODIMENTS

A logic circuit may be realized by either an application specific integrated circuit (ASIC) or a field-programmable gate array (FPGA) depending on its characteristics. For the purpose of improved quality, shortened logic verification period or codesign of hardware design and software verification, an ASIC register transfer level (RTL) operation model may be wished to be mounted on the FPGA. However, the ASIC RTL operation model may not be used as an FPGA RTL operation model. In that case, with the existing technology, the FPGA RTL operation model has to be redesigned, leading to the prolonged design period.

### First Embodiment

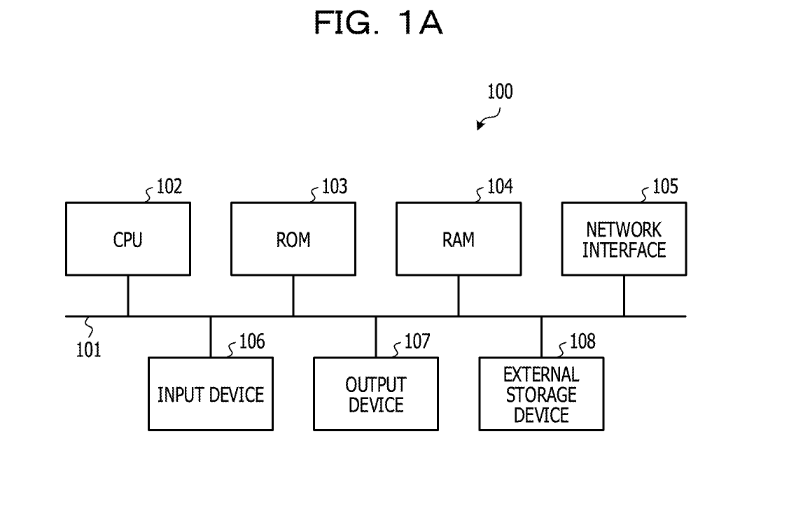

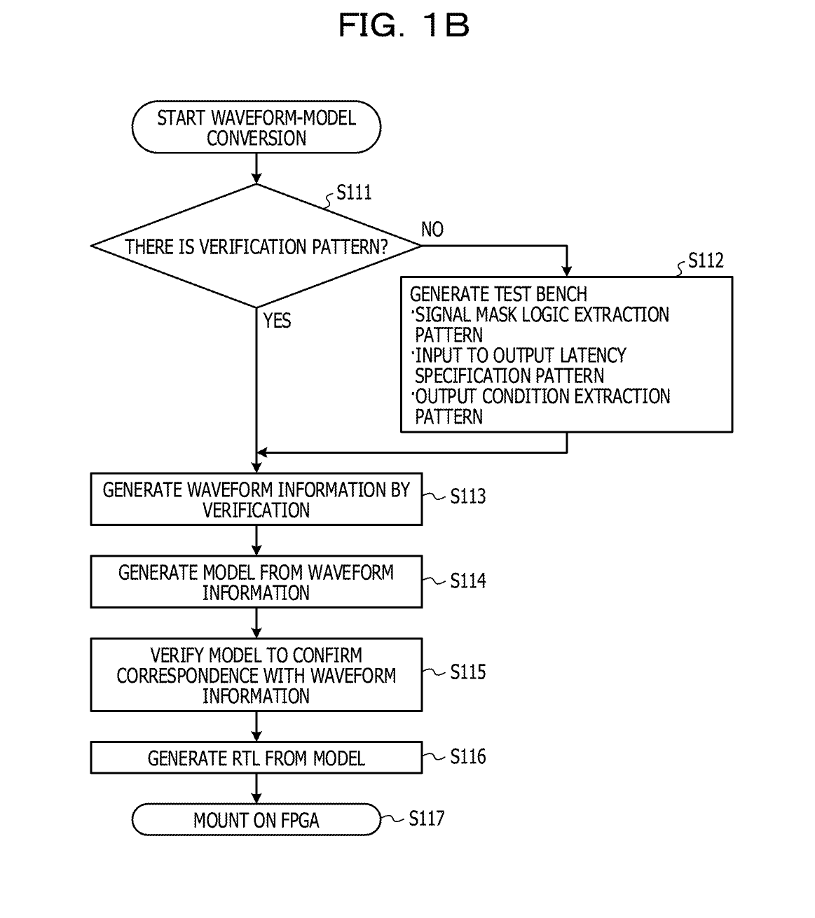

FIG. 1A is a diagram illustrating a hardware configuration example of an information processor 100 according to a first embodiment. The information processor 100 is a computer, including a bus 101, a central processing unit (CPU) 102, a read-only memory (ROM) 103, a random access memory (RAM) 104, a network interface 105, an input device 106, an output device 107, and an external storage device 108. The information processor 100 is an example of an operation model generator.

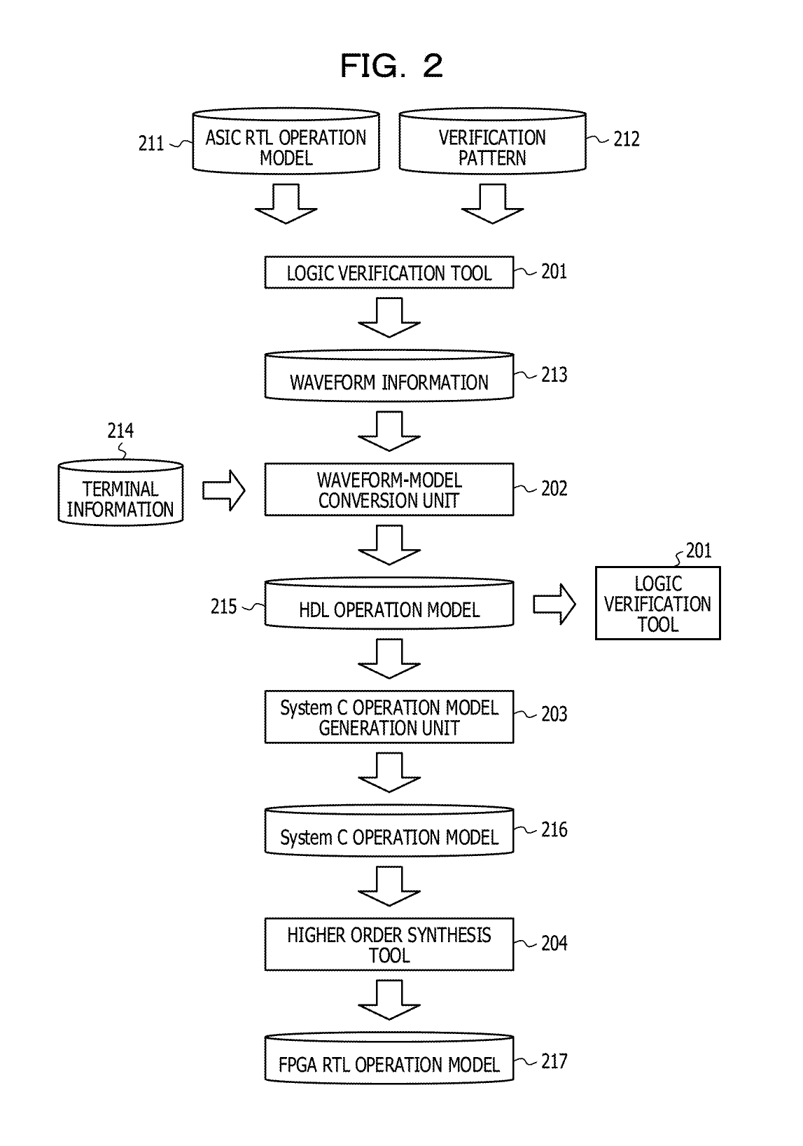

The CPU 102 performs data processing or operation, and also controls the various constituent components connected through the bus 101. The ROM 103 stores a startup program. The CPU 102 starts by executing the startup program in the ROM 103. The external storage device 108 stores programs including a logic verification tool 201, a waveform-model conversion unit 202, a System C operation model generation unit 203, and a higher order synthesis tool 204 illustrated in FIG. 2. The CPU 102 executes the programs stored in the external storage device 108 by developing the programs into the RAM 104. The RAM 104 stores programs and data. The external storage device 108 is a hard disk storage device, a CD-ROM, or the like, for example, having its memory content not erased even after the power is turned off. The network interface 105 is an interface for connecting to a network such as the Internet. The input device 106 is a keyboard, a mouse, and the like, for example, capable of various designations, input, or the like. The output device 107 is a display, a printer, and the like.

This embodiment may be realized by the computer executing the program. A computer-readable recording medium recording the above program and a computer program product such as the above program may be applied as embodiments. As the recording medium, a flexible disk, a hard disk, an optical disk, a magneto optical disk, a CD-ROM, a magnetic tape, a non-volatile memory card, a ROM, and the like may be used.

FIG. 1B is a flowchart illustrating an information processing method for the information processor 100. FIG. 2 is a diagram illustrating programs and data in the information processor 100. The logic verification tool 201, the waveform-model conversion unit 202, the System C operation model generation unit 203, and the higher order synthesis tool 204 are programs executed by the CPU 102. An ASIC register transfer level (RTL) operation model 211 is an operation model for a logic circuit, which is stored in the external storage device 108. When the ASIC RTL operation model 211 may be used as an FPGA RTL operation model, the ASIC RTL operation model 211 may be mounted on the FPGA. When the ASIC RTL operation model 211 may not be used as the FPGA RTL operation model, the information processor 100 converts the ASIC RTL operation model 211 into an FPGA RTL operation model 217. Logic circuit information based on the FPGA RTL operation model 217 is written into the FPGA.

In Step S111, a user checks if there is a verification pattern 212 of the ASIC RTL operation model 211. The verification pattern 212 is an input signal pattern for verifying the ASIC RTL operation model 211. The processing advances to Step S113 when there is the verification pattern 212, and advances to Step S112 when there is no verification pattern 212.

In Step S112, the user generates the verification pattern 212 of the ASIC RTL operation model 211 for generating a test bench. For example, the user generates the verification pattern 212 including a signal mask logic extraction pattern, an input to output latency specification pattern, and an output condition extraction pattern. The verification pattern 212 is stored in the external storage device 108. Thereafter, the processing advances to Step S113.

In Step S113, the CPU 102 executes the logic verification tool 201 to verify the ASIC RTL operation model 211 with the verification pattern 212, thus generates waveform information 213, and writes the waveform information 213 into the external storage device 108. The waveform information 213 includes waveform information of an input signal and an output signal of the ASIC RTL operation model 211. The input signal corresponds to the verification pattern 212. The logic verification tool 201 is a waveform information generation unit that generates the waveform information 213.

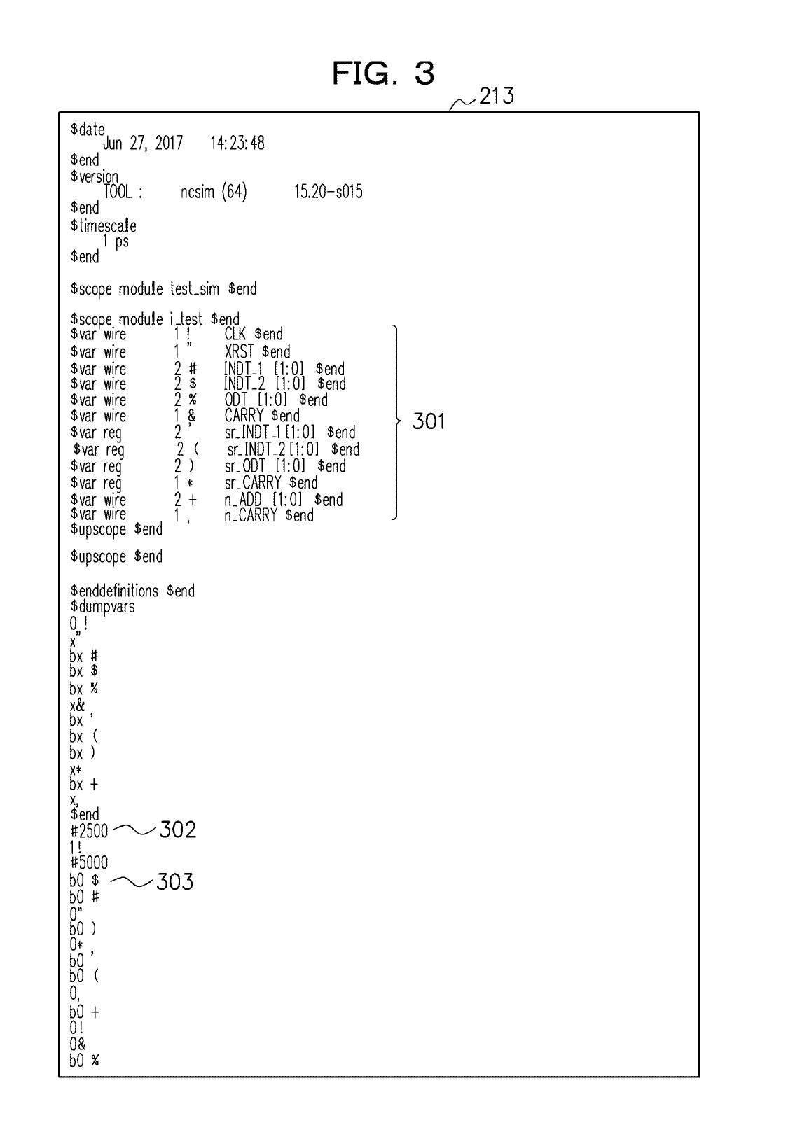

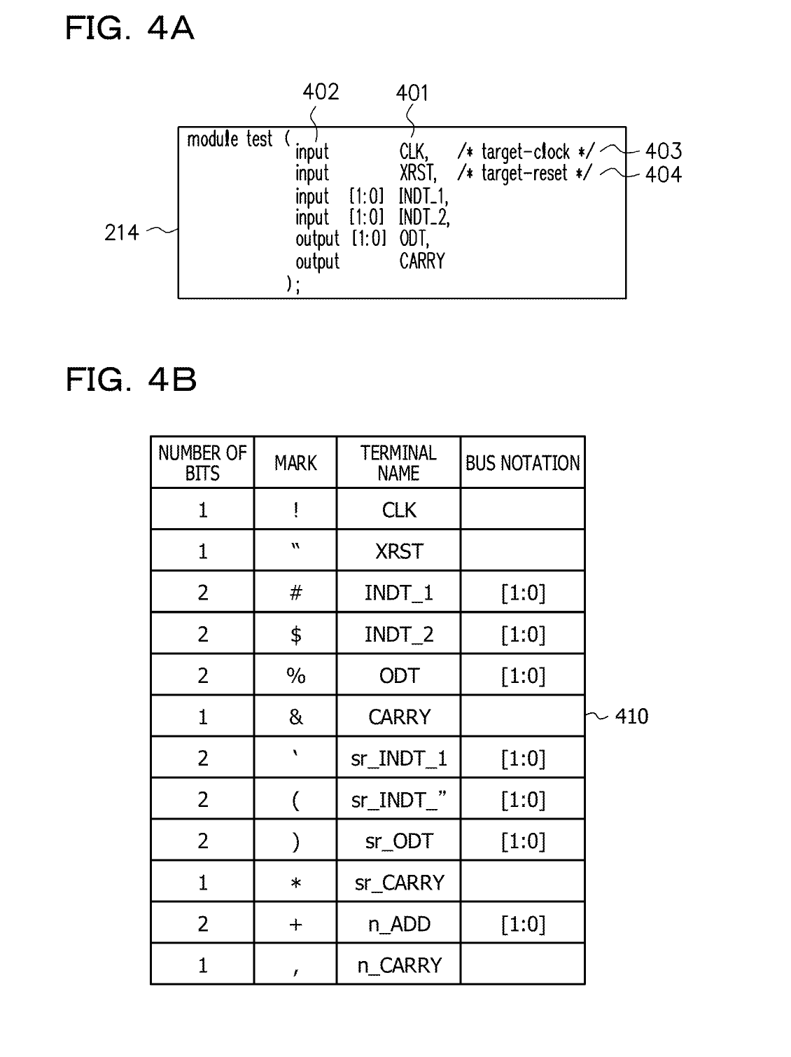

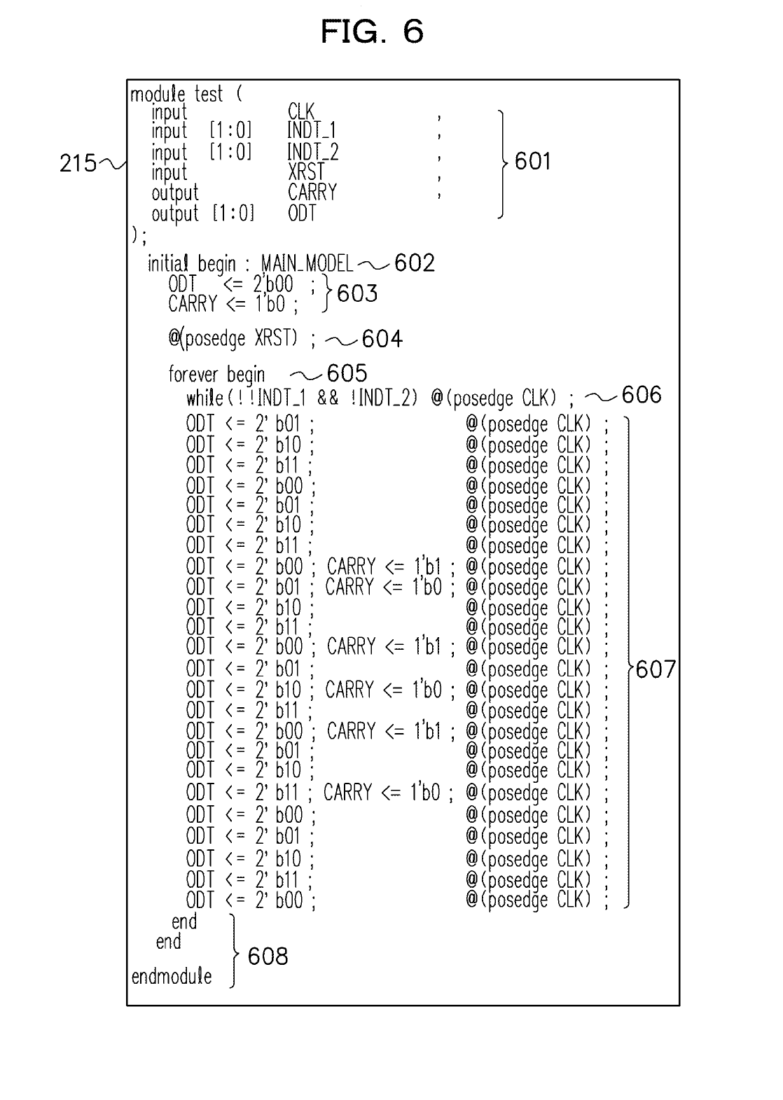

Next, in Step S114, the CPU 102 executes the waveform-model conversion unit (program) 202 to generate a hardware description language (HDL) operation model 215 based on the waveform information 213 and terminal information 214, and writes the HDL operation model 215 into the external storage device 108. The waveform-model conversion unit 202 is an operation model generation unit that generates the HDL operation model 215. The HDL is, for example, a Verilog-HDL or a VHDL. The terminal information 214 includes information of an input terminal and an output terminal of the logic circuit, and is stored in the external storage device 108. The waveform information 213 is described in detail later with reference to FIG. 3. The terminal information 214 is described in detail later with reference to FIG. 4A. The HDL operation model 215 is described in detail later with reference to FIG. 6.

Next, in Step S115, the CPU 102 executes the logic verification tool 201 to verify the HDL operation model 215 with the verification pattern 212, and confirms that waveform information to be generated corresponds to the waveform information 213 described above.

Then, in Step S116, the CPU 102 executes the System C operation model generation unit (program) 203 to generate a System C operation model 216 based on the HDL operation model 215, and writes the System C operation model 216 into the external storage device 108. System C is a higher order synthesis language based on C/C⁺⁺ language. The System C operation model generation unit 203 may generate the System C operation model 216 including a synthesis script. For example, the System C operation model generation unit 203 analyzes the HDL operation model 215 to generate a syntax tree model, analyzes the syntax tree model to extract analysis information, and then reconfigures the syntax tree model based on the syntax tree model and the analysis information, thus generating the System C operation model 216. For example, the System C operation model generation unit 203 may use a method described in International Application PCT/JP2018/012695 to generate the System C operation model 216.

Next, the CPU 102 executes the higher order synthesis tool 204 to generate the FPGA RTL operation model 217 based on the System C operation model 216.

Then, in Step S117, the user writes logic circuit information based on the FPGA RTL operation model 217 into the FPGA. Thus, the FPGA constructs a logic circuit and becomes operable.

FIG. 3 is a diagram illustrating an example of the waveform information 213 in FIG. 2. The logic verification tool 201 uses the verification pattern 212 to verify the ASIC RTL operation model 211 and thus generate the waveform information 213. FIG. 3 illustrates an example where the waveform information 213 is a value change dump (VCD) file. The waveform information 213 includes terminal information 301 of a logic circuit, time information 302 of a signal change in a terminal of the logic circuit, and signal change information 303 of the terminal of the logic circuit. The terminal information 301 does not include information indicating whether each terminal is an input terminal or an output terminal. Therefore, the terminal information 214 in FIG. 2 is prepared.

FIG. 4A is a diagram illustrating an example of the terminal information 214 in FIG. 2. Next, a method for generating the terminal information 214 is described. The user generates the terminal information 214 based on input-output terminal information in specifications of the logic circuit. Alternatively, the user may generate the terminal information 214 by extracting input-output terminal information of the ASIC RTL operation model 211. Alternatively, the user may generate the terminal information 214 by extracting from destination information of the ASIC RTL operation model 211 that instances a target logic circuit. The terminal information 214 includes a terminal name 401, input-output information 402, a clock terminal name 403, and a reset terminal name 404.

The waveform-model conversion unit 202 extracts the terminal name 401, the input-output information 402, the clock terminal name 403, and the reset terminal name 404 in the terminal information 214. In the input-output information 402, “input” indicates the input terminal and “output” indicates the output terminal. For example, a terminal CLK is a 1-bit input terminal. A terminal XRST is a 1-bit input terminal. A terminal INDT_1 is a 2-bit input terminal. A terminal INDT_2 is a 2-bit input terminal. A terminal ODT is a 2-bit output terminal. A terminal CARRY is a 1-bit output terminal. The clock terminal name 403 indicates that the terminal CLK is a clock terminal. The reset terminal name 404 indicates that the terminal XRST is a reset terminal.

FIG. 4B is a diagram illustrating an example of a terminal table 410. The waveform-model conversion unit 202 generates a terminal table 410 based on the terminal information 301 in the waveform information 213 in FIG. 3. The terminal table 410 represents correspondence relationships between the number of bits, mark, terminal name, and bus (BUS) notation. For example, the number of bits for the terminal name CLK is 1, which is represented by “!” mark and has no BUS notation. The number of bits for the terminal name XRST is 1, which is represented by “″” mark and has no BUS notation. The number of bits for the terminal name INDT_1 is 2, which is represented by “#” mark and has a BUS notation [1:0]. The number of bits for the terminal name INDT_2 is 2, which is represented by “$” mark and has a BUS notation [1:0]. The number of bits for the terminal name ODT is 2, which is represented by “%” mark and has a BUS notation [1:0]. The number of bits for the terminal name CARRY is 1, which is represented by “&” mark and has no BUS notation.

For example, the signal change information 303 in FIG. 3 is information indicating that the signal of the terminal INDT_2 represented by “$” mark is changed to “0”. The waveform information 213 has information indicating a signal value of the input terminal and a signal value of the output terminal of the logic circuit.

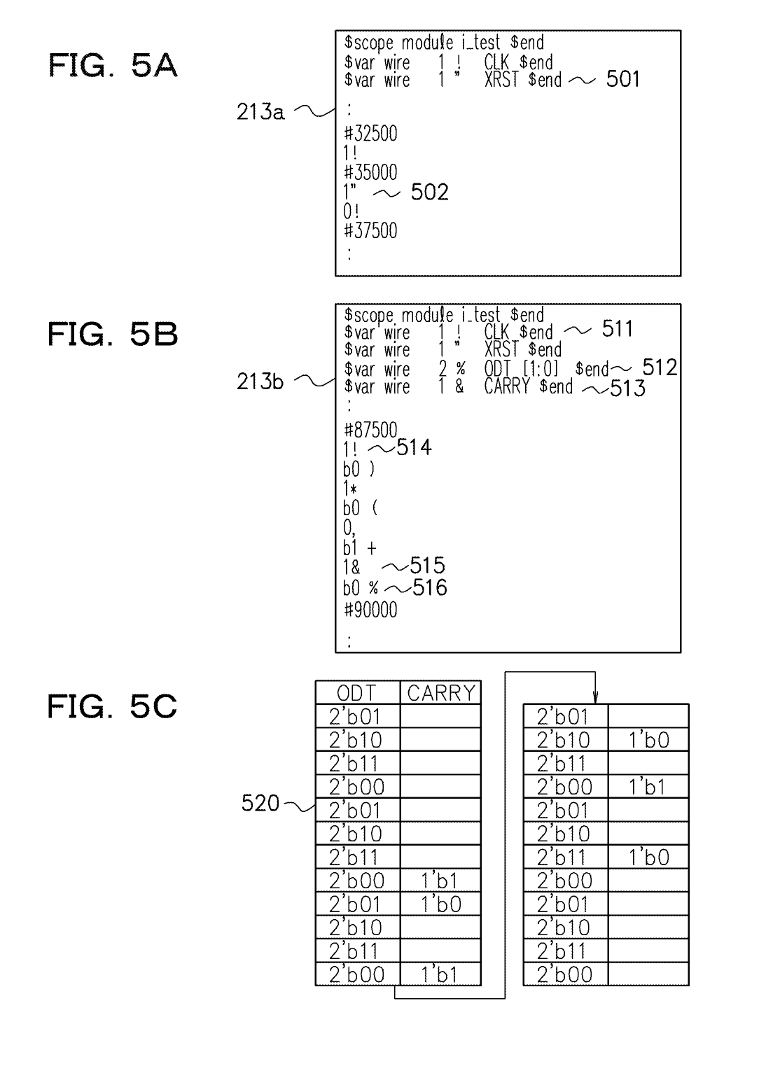

FIG. 5A is a diagram illustrating an example of a part of the waveform information 213. The waveform information 213a has descriptions 501 and 502. The description 501 indicates that the reset terminal XRST has a mark “″”. The description 502 indicates that the signal of the reset terminal XRST having the mark “″” is changed to 1 (reset cancelled). The waveform-model conversion unit 202 extracts the description 502 indicating that the signal of the reset terminal XRST is changed to “1” (description indicating that the reset signal is cancelled) from the waveform information 213a.

FIG. 5B is a diagram illustrating an example of another part 213b of the waveform information 213. The waveform information 213b has descriptions 511 to 516. The description 511 indicates that the clock terminal CLK has a mark “!”. The description 512 indicates that the output terminal ODT has a mark “%”. The description 513 indicates that the output terminal CARRY has a mark “&”. The description 514 indicates a spot where the signal of the clock terminal CLK having the mark “!” is changed to 1. The description 515 indicates a spot where the signal of the output terminal CARRY having the mark “&” is changed to 1. The description 516 indicates a spot where the signal of the output terminal ODT having the mark “%” is changed to 0. The waveform-model conversion unit 202 extracts the descriptions 515 and 516 indicating the signal values of the output terminals ODT and CARRY in the description 514 indicating the spot where the signal of the clock terminal CLK is changed to “1” (after the clock signal is changed to “1”) from the waveform information 213b.

FIG. 5C is a diagram illustrating an example of a database 520. The waveform-model conversion unit 202 generates the database 520 of the signal values of the output terminals at the spot where the signal of the clock terminal CLK is changed to 1, based on the waveform information 213. The spot where the signal of the clock terminal CLK is changed to 1 indicates a signal cycle of the clock terminal CLK. The database 520 indicates the signal values of the output terminals ODT and CARRY for each signal cycle (for each cycle number) of the signal of the clock terminal CLK. In the first cycle, for example, the signal value of the output terminal ODT is “01”. In the eighth cycle, the signal value of the output terminal ODT is “00” and the signal value of the output terminal CARRY is “1”.

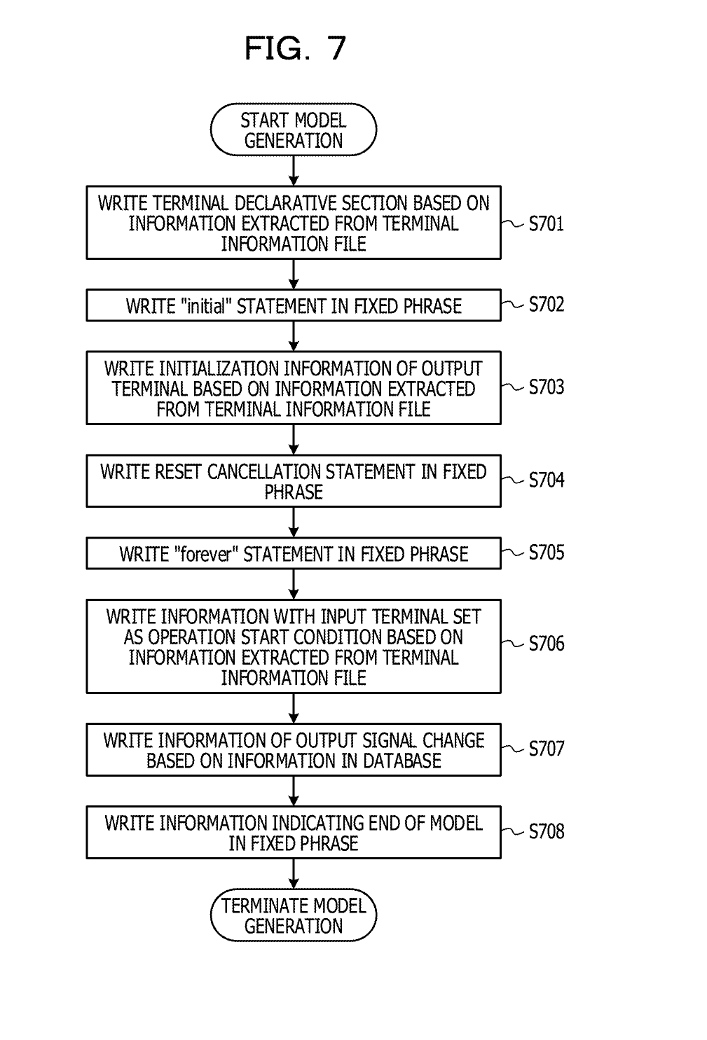

FIG. 6 is a diagram illustrating an example of the HDL operation model 215 in FIG. 2. FIG. 7 is a flowchart illustrating a processing example of the waveform-model conversion unit 202. Hereinafter, description is given of an example where the waveform-model conversion unit 202 generates the HDL operation model 215.

In Step S701, the waveform-model conversion unit 202 writes a terminal declarative section 601 in the HDL operation model 215 in FIG. 6 based on the information extracted from the file of the terminal information 214 in FIG. 4A. The terminal declarative section 601 has the same content as that of the terminal information 214.

Next, in Step S702, the waveform-model conversion unit 202 writes an “initial” statement 602 in a fixed phrase, in the HDL operation model 215 in FIG. 6.

Then, in Step S703, the waveform-model conversion unit 202 writes initialization information 603 for the output terminals ODT and CARRY, in the HDL operation model 215 in FIG. 6, based on the information extracted from the file of the terminal information 214.

Thereafter, in Step S704, the waveform-model conversion unit 202 writes a reset cancellation statement 604 in a fixed phrase, in the HDL operation model 215 in FIG. 6.

Subsequently, in Step S705, the waveform-model conversion unit 202 writes a forever statement 605 in a fixed phrase, in the HDL operation model 215 in FIG. 6.

Next, in Step S706, the waveform-model conversion unit 202 writes information 606 with the input terminals INDT_1 and INDT_2 as operation start conditions, in the HDL operation model 215 in FIG. 6, based on the information extracted from the file of the terminal information 214.

Then, in Step S707, the waveform-model conversion unit 202 writes information 607 of the signal values of the output terminals for each signal cycle (for each cycle number) of the clock terminal CLK, in the HDL operation model 215 in FIG. 6, based on the information in the database 520 of FIG. 5C. The information 607 is an operation description of the signal values of the output terminals ODT and CARRY for each signal cycle of the clock terminal CLK.

Thereafter, in Step S708, the waveform-model conversion unit 202 writes information 608 indicating the end of the HDL operation model 215 in a fixed phrase, in the HDL operation model 215 in FIG. 6.

Through the above processing, the HDL operation model 215 is completed. Thereafter, as illustrated in FIG. 2, the System C operation model generation unit 203 generates the System C operation model 216 based on the HDL operation model 215. The higher order synthesis tool 204 generates the FPGA RTL operation model 217 based on the System C operation model 216.

When the ASIC RTL operation model 211 may not be used as the FPGA RTL operation model, the information processor 100 may convert the ASIC RTL operation model 211 into the FPGA RTL operation model 217. Thus, the user does not have to manually redesign the FPGA RTL operation model 217, and may shorten the design period for the FPGA RTL operation model 217.

### Second Embodiment

In FIG. 6, the change information 607 of the output terminals ODT and CARRY are described in the HDL operation model 215 without any change made thereto. Therefore, the longer the waveform information (VCD file) 213, the larger the HDL operation model 215 in FIG. 6. An increase in the size of the HDL operation model 215 leads to increases in the size of the FPGA RTL operation model 217 and in the circuit size after logic synthesis. Therefore, measures have to be taken. In a second embodiment, an information processor 100 may reduce the circuit size by generating an HDL operation model 215 according to a procedure to be described later. Hereinafter, differences between the first and second embodiments are described.

The waveform-model conversion unit 202 extracts the following four information from the waveform information 213. First, the waveform-model conversion unit 202 extracts information of a terminal name and a mark indicating the terminal name used in the terminal information 214, as in the case of the first embodiment. Secondly, the waveform-model conversion unit 202 extracts the spot where the signal of the reset terminal XRST is changed to “1” (spot where the reset signal is cancelled) as in the case of the first embodiment. Third, the waveform-model conversion unit 202 extracts the signal values of the input terminals INDT_1 and INDT_2 at the spot where the signal is changed, as described later. Fourth, the waveform-model conversion unit 202 extracts the signal values of the output terminals ODT and CARRY for each spot where the signal of the clock terminal CLK is changed to “1”, as described later.

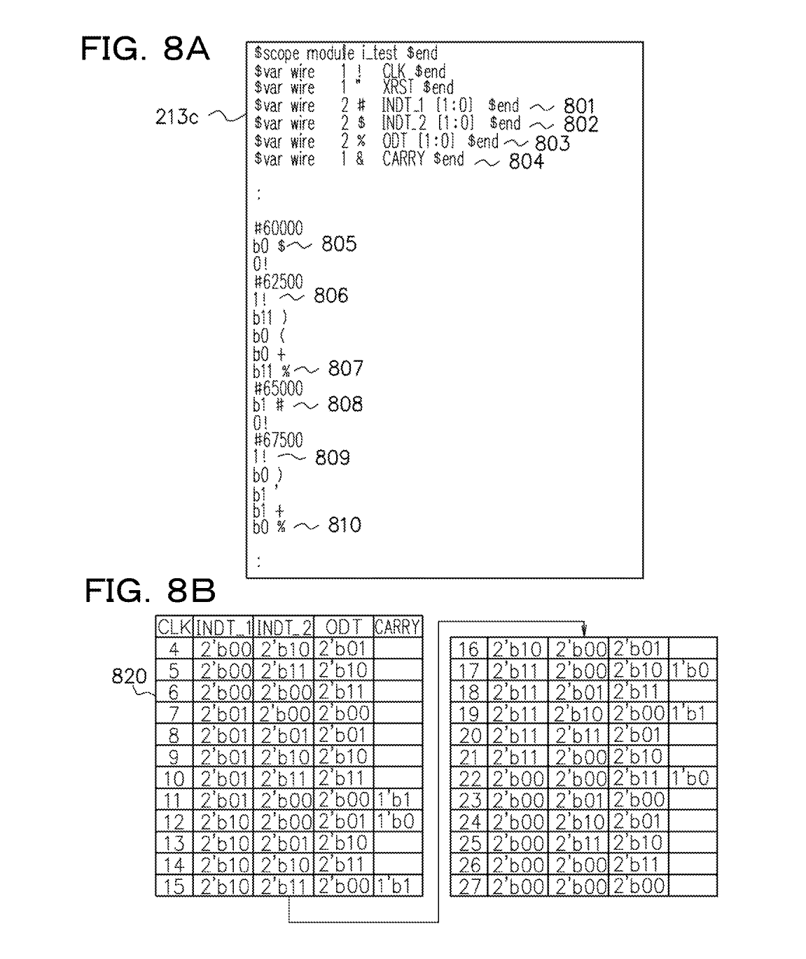

FIG. 8A is a diagram illustrating an example of a part 213c of the waveform information 213. A description 801 indicates that the input terminal INDT_1 has a mark “#”. A description 802 indicates that the input terminal INDT_2 has a mark “$”. A description 803 indicates that the output terminal ODT has a mark “%”. A description 804 indicates that the output terminal CARRY has a mark “&”.

A description 805 indicates a spot where the signal of the input terminal INDT_2 having the mark “$” is changed to “0”. A description 806 indicates a spot where the signal of the clock terminal CLK having the mark “!” is changed to “1”. A description 807 indicates a spot where the signal of the output terminal ODT having the mark “%” is changed to “11”. A description 808 indicates a spot where the signal of the input terminal INDT_1 having the mark “#” is changed to “1”. A description 809 indicates a spot where the signal of the clock terminal CLK having the mark “!” is changed to “1”. A description 810 indicates a spot where the signal of the output terminal ODT having the mark “%” is changed to “0”.

The waveform-model conversion unit 202 extracts the signal values of the input terminals INDT_1 and INDT_2 in the descriptions 805 and 808 indicating that the signals of the input terminals INDT_1 and INDT_2 are changed. The waveform-model conversion unit 202 also extracts the descriptions 807 and 810 of the signal values of the output terminals ODT and CARRY for each of the descriptions 806 and 809 in which the signal of the clock terminal CLK is changed to “1”.

FIG. 8B is a diagram illustrating an example of a database 820. The waveform-model conversion unit 202 generates the database 820 of the signal values of the output terminals ODT and CARRY, corresponding to the signal values of the input terminals INDT_1 and INDT_2, based on the waveform information 213. A spot where the signal of the clock terminal CLK is changed to 1 indicates a signal cycle of the clock terminal CLK. The database 820 represents correspondence relationships between the cycle number of the signal of the clock terminal CLK, the signal value of the input terminal INDT_1, the signal value of the input terminal INDT_2, the signal value of the output terminal ODT, and the signal value of the output terminal CARRY. In the fourth cycle, for example, the signal value of the input terminal INDT_1 is “00”, the signal value of the input terminal INDT_2 is “10”, and the signal value of the output terminal ODT is “01”.

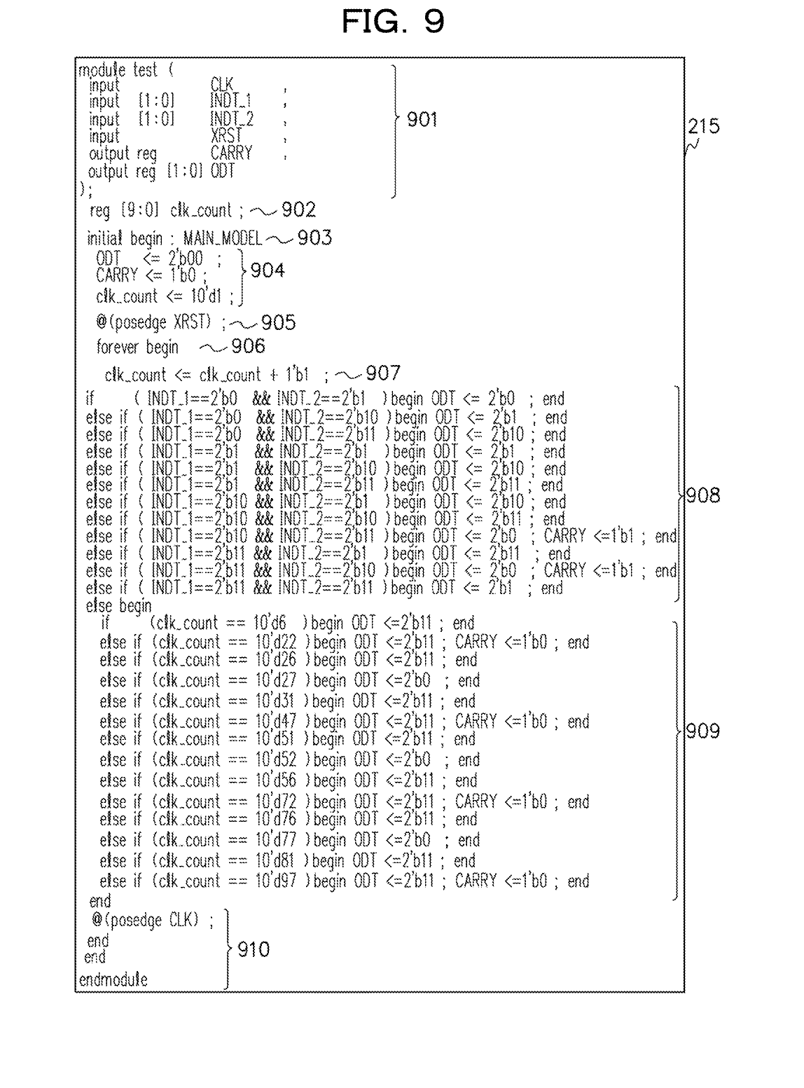

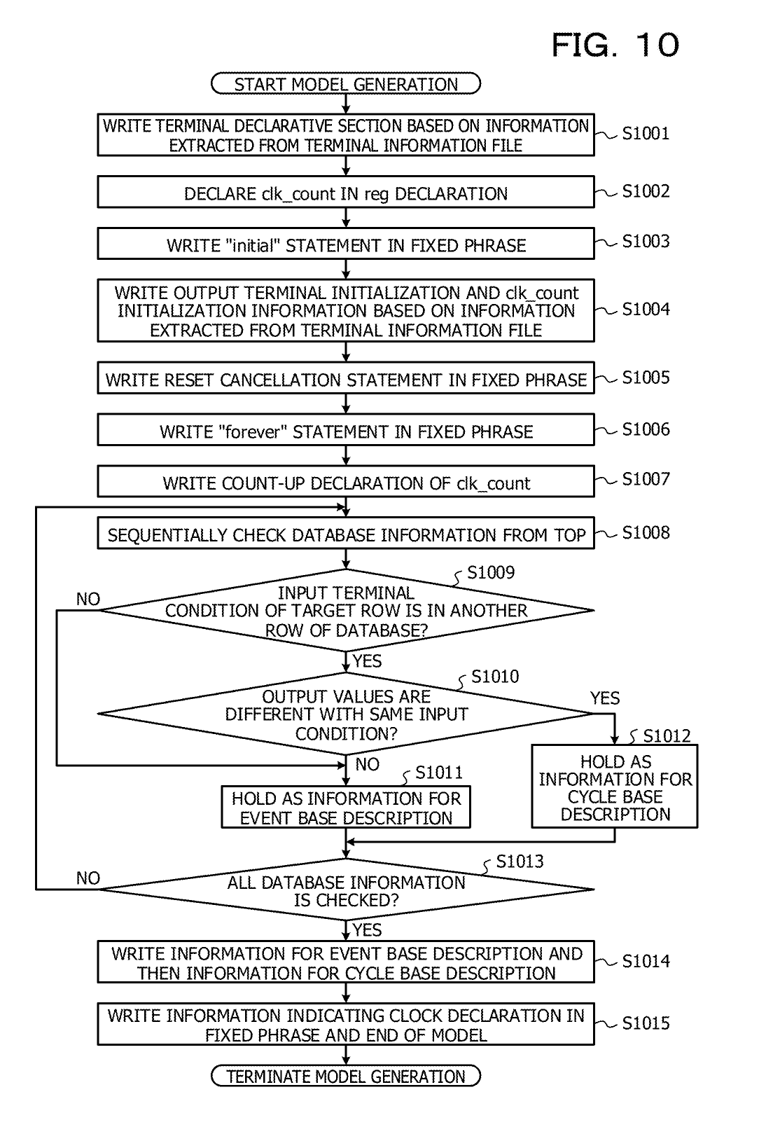

FIG. 9 is a diagram illustrating an example of the HDL operation model 215 in FIG. 2. FIG. 10 is a flowchart illustrating a processing example of the waveform-model conversion unit 202. Hereinafter, description is given of an example where the waveform-model conversion unit 202 generates the HDL operation model 215 in FIG. 9.

In Step S1001, the waveform-model conversion unit 202 writes a terminal declarative section 901 in the HDL operation model 215 in FIG. 9 based on the information extracted from the file of the terminal information 214 in FIG. 4A. The terminal declarative section 901 has the same content as that of the terminal information 214.

Next, in Step S1002, the waveform-model conversion unit 202 writes a declaration 902 of a register-type variable clk_count in reg declaration, in the HDL operation model 215 in FIG. 9. The variable clk_count corresponds to the cycle number of the clock terminal CLK signal.

Then, in Step S1003, the waveform-model conversion unit 202 writes an “initial” statement 903 in a fixed phrase, in the HDL operation model 215 in FIG. 9.

Thereafer, in Step S1004, the waveform-model conversion unit 202 writes initialization information 904 for the output terminals ODT and CARRY and the variable clk_count, in the HDL operation model 215 in FIG. 9, based on the information extracted from the file of the terminal information 214.

Subsequently, in Step S1005, the waveform-model conversion unit 202 writes a reset cancellation statement 905 in a fixed phrase, in the HDL operation model 215 in FIG. 9.

Next, in Step S1006, the waveform-model conversion unit 202 writes a forever statement 906 in a fixed phrase, in the HDL operation model 215 in FIG. 9.

Then, in Step S1007, the waveform-model conversion unit 202 writes a count-up declaration 907 of the variable clk_count, in the HDL operation model 215 in FIG. 9.

Thereafter, in Step S1008, the waveform-model conversion unit 202 sequentially checks the information in the database 820 of FIG. 8B from the top.

Subsequently, in Step S1009, the waveform-model conversion unit 202 checks if the condition of the input terminals INDT_1 and INDT_2 in a target row of the database 820 is in another row of the database 820. The waveform-model conversion unit 202 advances to Step S1010 when the condition is in another row, and advances to Step S1011 when the condition is not in another row.

In the database 820 of FIG. 8B, the input terminal condition (signal condition of the input terminal) indicated in CLK=4 is “INDT_1=2′b00, INDT_2=2′b10”. Then, it is checked if this input terminal condition is in another row. As a result, the portion of CLK=24 has the same input terminal condition. Thus, the processing advances from Step S1009 to Step S1010.

In Step S1010, the waveform-model conversion unit 202 checks if the signal values of the output terminals ODT and CARRY are different, under the same signal value condition of the input terminals INDT_1 and INDT_2, in the target row and the another row described above, in the database 820. The waveform-model conversion unit 202 advances to Step S1011 when the signal values are not different, and advances to Step S1012 when the signal values are different.

For example, when the output terminal ODT is checked for CLK=4 and CLK=24 in the database 820 of FIG. 8B, it may be seen that “ODT=2′b01” is established for both. Thus, the processing advances from Step S1010 to Step S1011.

In Step S1011, the waveform-model conversion unit 202 holds the target row of the database 820 as information 908 for event base description, and advances to Step S1013. The information 908 for event base description is an operation description of the signal value of the output terminal ODT and/or CARRY, corresponding to the signal values of the input terminals INDT_1 and INDT_2.

In Step S1013, the waveform-model conversion unit 202 checks if all the information in the database 820 is checked. When all the information is not checked, the waveform-model conversion unit 202 returns to Step S1008 to repeat the above processing.

For example, in the database 820 of FIG. 8B, the input terminal condition indicated at CLK=6 is “INDT_1=2′b00, INDT_2=2′b00”. In Step S1009, the waveform-model conversion unit 202 checks if this input terminal condition is in another row. The input terminal condition at CLK=6 is the same as the input terminal conditions at CLK=22, CLK=26, and CLK=27. Thus, the waveform-model conversion unit 202 advances from Step S1009 to Step S1010. It may be seen that, as for the output terminal conditions at CLK=6, CLK=22, CLK=26, and CLK=27, the signal values of the output terminal ODT are different. Therefore, the waveform-model conversion unit 202 advances from Step S1010 to Step S1012.

In Step S1012, the waveform-model conversion unit 202 holds the target row of the database 820 as information 909 for cycle base description, and advances to Step S1013. The information 909 for cycle base description is an operation description of the signal value of the output terminal ODT and/or CARRY for each variable clk_count. The variable clk_count represents the cycle number of the clock terminal CLK signal.

When all the information in the database 820 is checked in Step S1013, the waveform-model conversion unit 202 advances to Step S1014. In Step S1014, the waveform-model conversion unit 202 writes the information 908 for event base description and then writes the information 909 for cycle base description in the HDL operation model 215 in FIG. 9.

Next, in Step S1015, the waveform-model conversion unit 202 writes a clock declaration in a fixed phrase and information 910 indicating the end of the HDL operation model 215, in the HDL operation model 215 in FIG. 9.

Through the above processing, the HDL operation model 215 in FIG. 9 is completed. Thereafter, as illustrated in FIG. 2, the System C operation model generation unit 203 generates the System C operation model 216 based on the HDL operation model 215. The higher order synthesis tool 204 generates the FPGA RTL operation model 217 based on the System C operation model 216.

The waveform-model conversion unit 202 generates the HDL operation model 215 including the information 908 for event base description and the information 909 for cycle base description. According to the second embodiment, the sizes of the HDL operation model 215 and the FPGA RTL operation model 217 may be reduced according to the waveform information 213, compared with the first embodiment.

### Third Embodiment

In the second embodiment, when the signal value of the output terminal is not uniquely determined by the input terminal condition, that is, when there is more than one signal of the output terminal depending on the input terminal condition, the information 909 for cycle base description is written in the HDL operation model 215. When the information 909 for cycle base description includes more than one condition for the variable clk_count, the size of the HDL operation model 215 and the circuit size may be increased as the size of the waveform information 213 is increased.

In order to solve the above problem, an information processor 100 according to a third embodiment may reduce the information 909 for cycle base description by using a signal value in the previous cycle as the input terminal condition. When the information 909 for cycle base description is desired even after the signal value of the input terminal in the previous cycle is added to the input terminal condition, the signal value of the input terminal in the further previous cycle (2 cycles before the current cycle) may be used as the input terminal condition. This cycle back trace operation may trace back up to the initial value of the signal value in the waveform information 213.

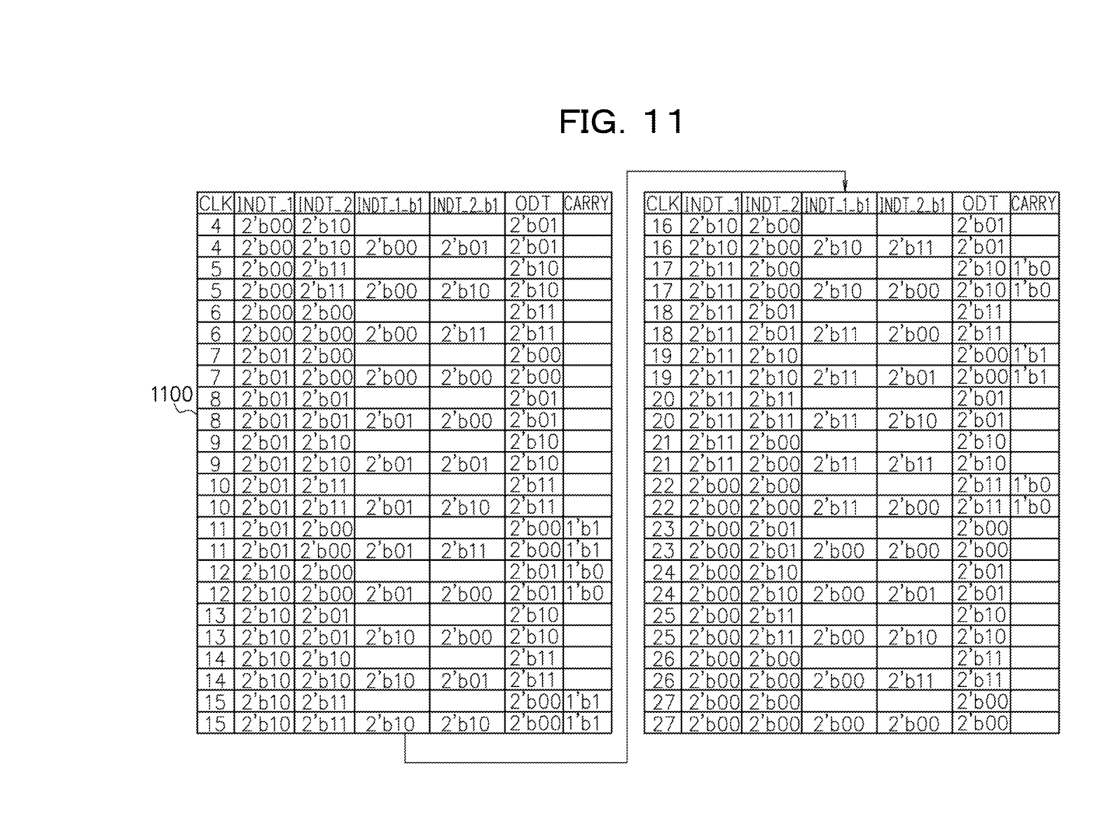

FIG. 11 is a diagram illustrating an example of a database 1100. The waveform-model conversion unit 202 generates the database 1100 of signal values of the output terminals ODT and CARRY, corresponding to the signal values of the input terminals INDT_1 and INDT_2 in the current cycle and signal values INDT_1_b1 and INDT_2_b1 in the previous cycle, based on the waveform information 213. The database 1100 represents correspondence relationships between the cycle number of the clock terminal CLK signal, the signal value of the input terminal INDT_1 in the current cycle, the signal value of the input terminal INDT_2 in the current cycle, the signal value INDT_1_b1 of the input terminal INDT_1 in the previous cycle, the signal value INDT_2_b1 of the input terminal INDT_2 in the previous cycle, the signal value of the output terminal ODT, and the signal value of the output terminal CARRY.

Each cycle number has a correspondence relationship between two rows. The first row represents a correspondence relationship between the signal value of the input terminal INDT_1 in the current cycle, the signal value of the input terminal INDT_2 in the current cycle, and the signal value of the output terminal ODT and/or CARRY. The second row represents a correspondence relationship between the signal value of the input terminal INDT_1 in the current cycle, the signal value of the input terminal INDT_2 in the current cycle, the signal value INDT_1_b1 of the input terminal INDT_1 in the previous cycle, the signal value INDT_2_b1 of the input terminal INDT_2 in the previous cycle, and the signal value of the output terminal ODT and/or CARRY.

In the first row of CLK=5 in FIG. 11, for example, the signal value of the input terminal INDT_1 in the current cycle is “00”, the signal value of the input terminal INDT_2 in the current cycle is “11”, and the signal value of the output terminal ODT is “10”. In the second row of CLK=5 in FIG. 11, the signal value of the input terminal INDT_1 in the current cycle is “00”, the signal value of the input terminal INDT_2 in the current cycle is “11”, the signal value INDT_1_b1 of the input terminal INDT_1 in the previous cycle is “00”, the signal value INDT_2_b1 of the input terminal INDT_2 in the previous cycle is “10”, and the signal value of the output terminal ODT is “10”.

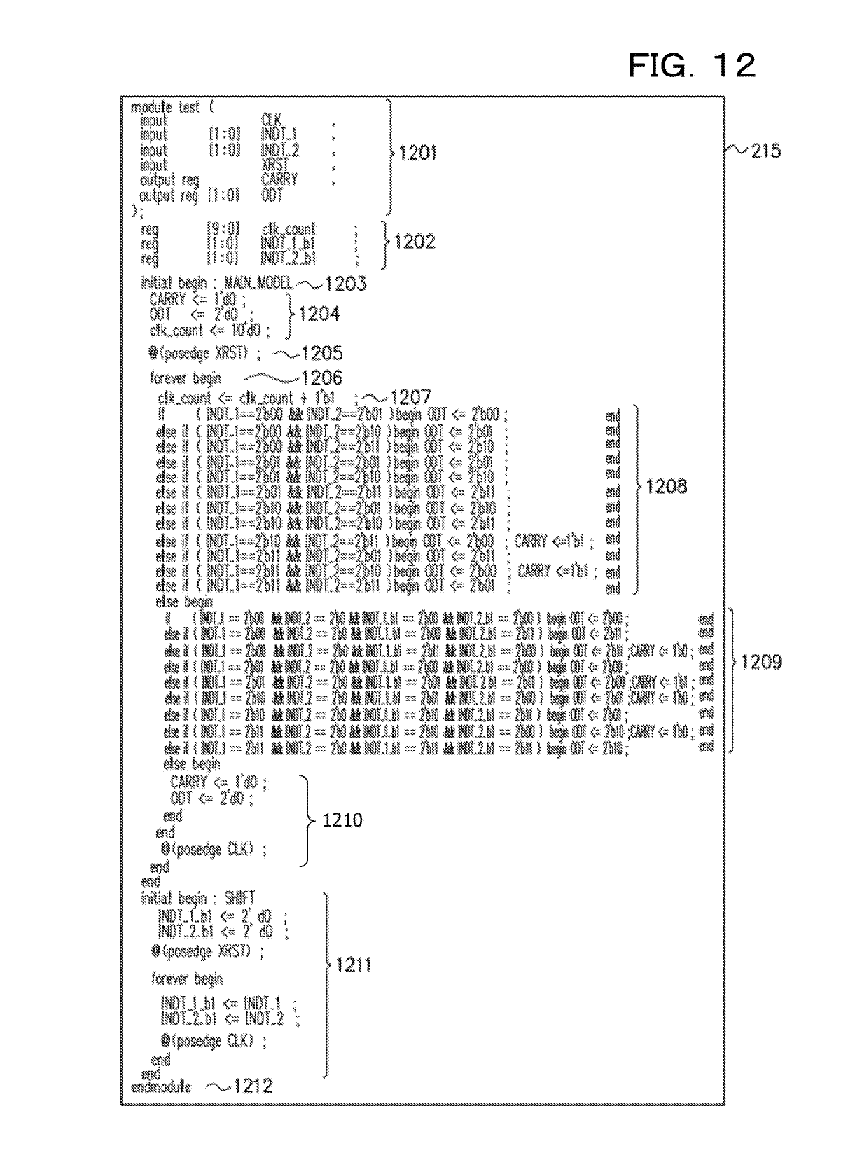

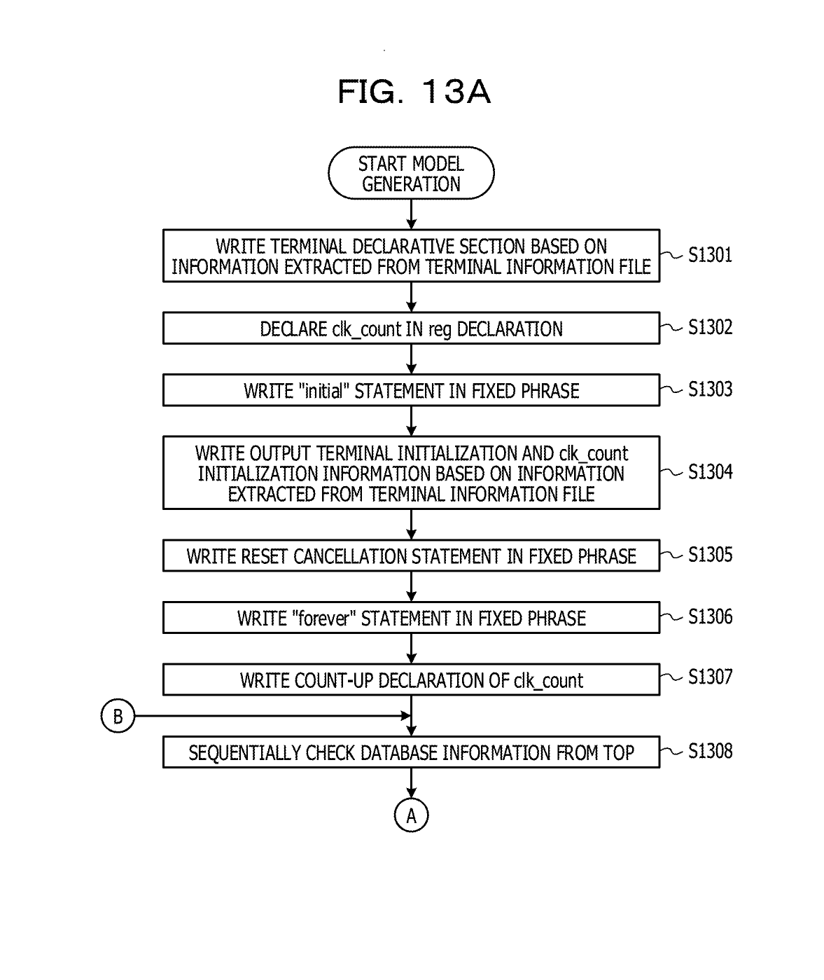

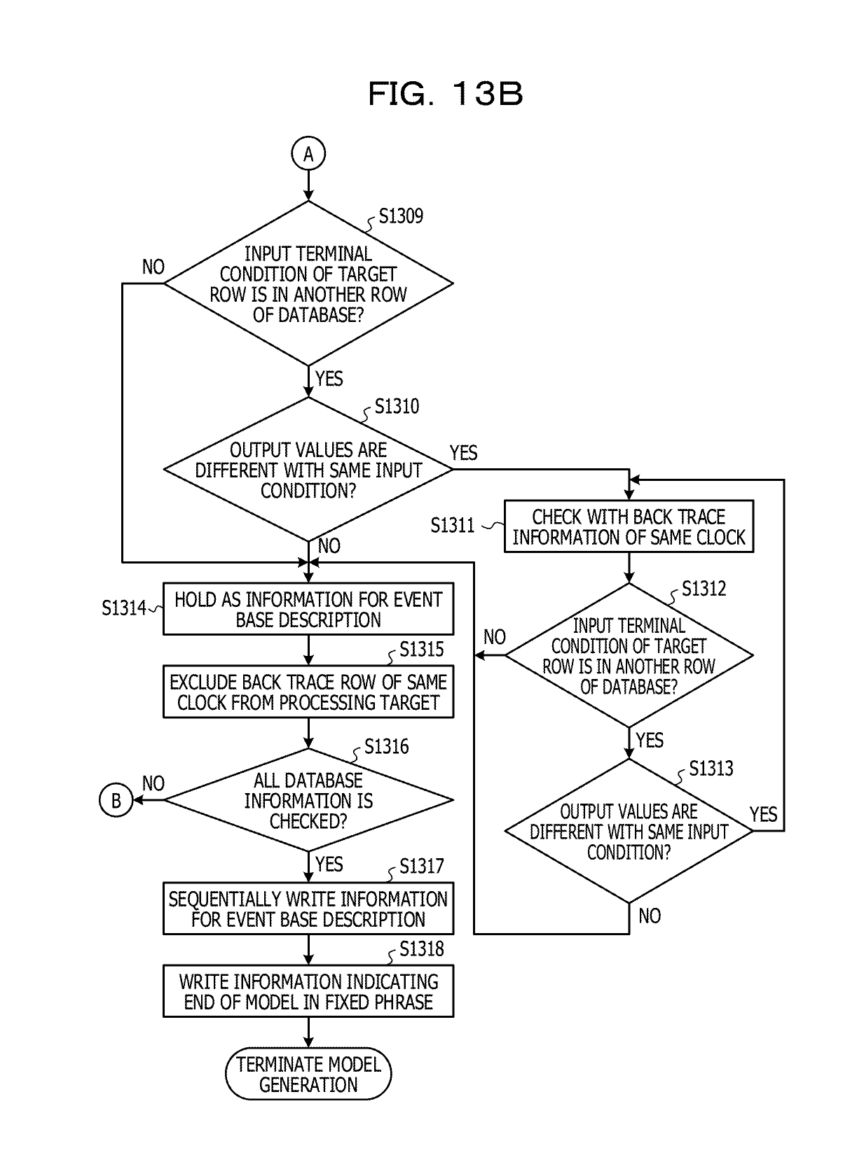

FIG. 12 is a diagram illustrating an example of the HDL operation model 215 in FIG. 2. FIG. 13 is a flowchart illustrating a processing example of the waveform-model conversion unit 202. Hereinafter, description is given of an example where the waveform-model conversion unit 202 generates the HDL operation model 215 in FIG. 12.

In Step S1301, the waveform-model conversion unit 202 writes a terminal declarative section 1201 in the HDL operation model 215 in FIG. 12 based on the information extracted from the file of the terminal information 214 in FIG. 4A. The terminal declarative section 1201 has the same content as that of the terminal information 214.

Next, in Step S1302, the waveform-model conversion unit 202 writes a declaration 1202 of register-type variables clk_count, INDT_1_b1, and INDT_2_b1 in reg declaration, in the HDL operation model 215 in FIG. 12. The variable clk_count corresponds to the cycle number of the clock terminal CLK signal. The variable INDT_1_b1 corresponds to the signal value of the input terminal INDT_1 in the previous cycle. The variable INDT_2_b1 corresponds to the signal value of the input terminal INDT_2 in the previous cycle.

Then, in Step S1303, the waveform-model conversion unit 202 writes an “initial” statement 1203 in a fixed phrase, in the HDL operation model 215 in FIG. 12.

Thereafer, in Step S1304, the waveform-model conversion unit 202 writes initialization information 1204 for the output terminals ODT and CARRY and the variable clk_count, in the HDL operation model 215 in FIG. 12, based on the information extracted from the file of the terminal information 214.

Subsequently, in Step S1305, the waveform-model conversion unit 202 writes a reset cancellation statement 1205 in a fixed phrase, in the HDL operation model 215 in FIG. 12.

Next, in Step S1306, the waveform-model conversion unit 202 writes a forever statement 1206 in a fixed phrase, in the HDL operation model 215 in FIG. 12.

Then, in Step S1307, the waveform-model conversion unit 202 writes a count-up declaration 1207 of the variable clk_count, in the HDL operation model 215 in FIG. 12.

Thereafter, in Step S1308, the waveform-model conversion unit 202 sequentially checks the information in the database 1100 of FIG. 11 from the top.

Subsequently, in Step S1309, the waveform-model conversion unit 202 checks if the condition of the signal values of the input terminals INDT_1 and INDT_2 in the current cycle in a target row of the database 1100 is in a first row of another cycle number of the database 1100. The waveform-model conversion unit 202 advances to Step S1310 when the condition is in the first row of another cycle number, and advances to Step S1314 when the condition is not in the first row of another cycle number.

In the database 1100 of FIG. 11, the input terminal condition indicated in the first row of CLK=4 is “INDT_1=2′b00, INDT_2=2′b10”. Then, it is checked if this input terminal condition is in another row. As a result, the first row of CLK=24 has the same input terminal condition. Thus, the processing advances from Step S1309 to Step S1310.

In Step S1310, the waveform-model conversion unit 202 checks if the signal values of the output terminals ODT and CARRY are different, under the same signal value condition of the input terminals INDT_1 and INDT_2, in the target row and the first row of the another cycle number described above, in the database 1100. The waveform-model conversion unit 202 advances to Step S1314 when the signal values are not different, and advances to Step S1311 when the signal values are different.

For example, when the output terminal ODT is checked for the first row of CLK=4 and the first row of CLK=24 in the database 1100 of FIG. 11, it may be seen that “ODT=2′b01” is established for both. Thus, the processing advances from Step S1310 to Step S1314.

In Step S1314, the waveform-model conversion unit 202 holds the target row of the database 1100 as information 1208 for event base description, and advances to Step S1315. The information 1208 for event base description is an operation description of the signal value of the output terminal ODT and/or CARRY, corresponding to the signal values of the input terminals INDT_1 and INDT_2 in the current cycle.

In Step S1315, the waveform-model conversion unit 202 excludes a second row (back trace row) of the clock terminal CLK cycle number having the same input terminal condition described above from the processing target. For example, since the input terminal condition for the first row of CLK=4 is uniquely determined, the waveform-model conversion unit 202 excludes the second row of CLK=4 and the second row of CLK=24 from the processing target.

Next, in Step S1316, the waveform-model conversion unit 202 checks if all the information in the database 1100 is checked. When all the information is not checked, the waveform-model conversion unit 202 returns to Step S1308 to repeat the above processing.

For example, in the database 1100 of FIG. 11, the input terminal condition indicated in the first row of CLK=6 is “INDT_1=2′b00, INDT_2=2′b00”. In Step S1309, the waveform-model conversion unit 202 checks if this input terminal condition is in a first row of another cycle number. The input terminal condition in the first row of CLK=6 is the same as the input terminal conditions in the first rows of CLK=22, CLK=26, and CLK=27. Thus, the waveform-model conversion unit 202 advances from Step S1309 to Step S1310. It may be seen that, as for the output terminal conditions in the first rows of CLK=6, CLK=22, CLK=26, and CLK=27, the signal values of the output terminal ODT are different. Therefore, the waveform-model conversion unit 202 advances from Step S1310 to Step S1311.

In Step S1311, the waveform-model conversion unit 202 performs the following check by referring to the back trace information in the second row of the clock terminal CLK cycle number having the same input terminal condition as that described above in the database 1100.

Next, in Step S1312, the waveform-model conversion unit 202 checks if the condition for the signal values INDT_1_b1 and INDT_2_b1 of the input terminals INDT_1 and INDT_2 in the previous cycle in the target row of the database 1100 is in the second row of another cycle number of the database 1100. The waveform-model conversion unit 202 advances to Step S1313 when the condition is in the second row of another cycle number, and advances to Step S1314 when the condition is not in the second row of another cycle number.

In the database 1100 of FIG. 11, the input terminal condition indicated in the second row of CLK=6 is “INDT_1=2′b00, INDT_2=2′b00, INDT_1_b1=2′b00, INDT_2_b1=2′b11”. Then, it is checked if this input terminal condition is in the second row of another cycle number. As a result, the second row of CLK=26 has the same input terminal condition. Thus, the processing advances from Step S1312 to Step S1313.

In Step S1313, the waveform-model conversion unit 202 checks if the signal values of the output terminals ODT and CARRY are different, under the same condition for the signal values INDT_1_b1 and INDT_2_b1, in the target row and the second row of the another cycle number described above, in the database 1100. The waveform-model conversion unit 202 advances to Step S1314 when the signal values are not different. The waveform-model conversion unit 202 returns to Step S1311, when the signal values are different, to repeat the processing for the signal values of the input terminals INDT_1 and INDT_2 in the previous cycle.

For example, when the output terminal ODT is checked for the second rows of CLK=6 and CLK=26 in the database 1100 of FIG. 11, it may be seen that “ODT=2′b11” is established for both. Thus, the processing advances from Step S1313 to Step S1314.

In Step S1314, the waveform-model conversion unit 202 holds the second row of the target cycle number in the database 1100 as information 1209 for event base description, and advances to Step S1315. The information 1209 for event base description is an operation description of the signal value of the output terminal ODT and/or CARRY, corresponding to the signal values of the input terminals INDT_1 and INDT_2 in the current cycle and the signal values INDT_1_b1 and INDT_2_b1 thereof in the previous cycle.

In Step S1316, the waveform-model conversion unit 202 advances to Step S1317 when all the information in the database 1100 is checked. In Step S1317, the waveform-model conversion unit 202 writes information 1208 for event base description and then writes information 1209 for event base description in the HDL operation model 215 in FIG. 12. Then, the waveform-model conversion unit 202 writes the signal values of the output terminals ODT and CARRY in the case of another input terminal condition as well as a clock declaration 1210 in the HDL operation model 215 in FIG. 12. Thereafter, the waveform-model conversion unit 202 writes a shift register description 1211 for generating back trace signal values INDT_1_b1 and INDT_2_b1 in the HDL operation model 215 in FIG. 12.

Next, in Step S1318, the waveform-model conversion unit 202 writes information 1212 indicating the end of the HDL operation model 215 in a fixed phrase, in the HDL operation model 215 in FIG. 12.

Through the above processing, the HDL operation model 215 in FIG. 12 is completed. Thereafter, as illustrated in FIG. 2, the System C operation model generation unit 203 generates the System C operation model 216 based on the HDL operation model 215. The higher order synthesis tool 204 generates the FPGA RTL operation model 217 based on the System C operation model 216.

The waveform-model conversion unit 202 generates the HDL operation model 215 including the information 1208 and 1209 for event base description. According to the third embodiment, the sizes of the HDL operation model 215 and the FPGA RTL operation model 217 may be reduced according to the waveform information 213, compared with the second embodiment.

### Fourth Embodiment

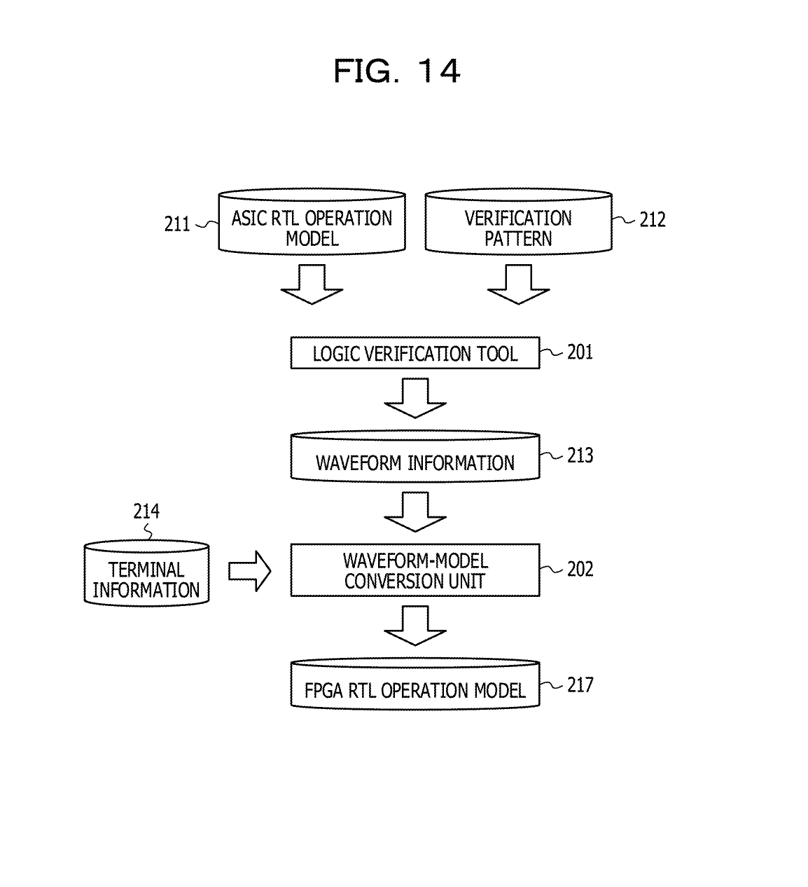

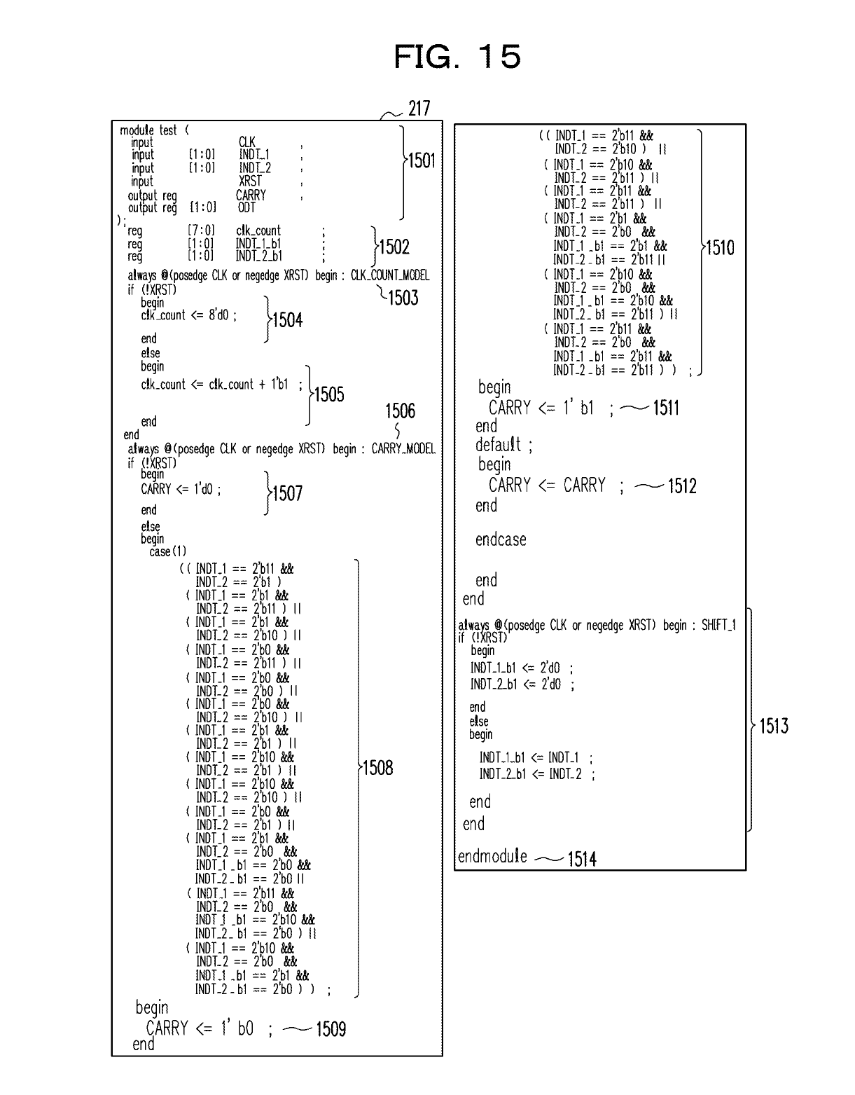

FIG. 14 is a diagram illustrating programs and data in the information processor 100 according to a fourth embodiment. In FIG. 2, the waveform-model conversion unit 202 generates the HDL operation model 215 based on the waveform information 213 and the terminal information 214. On the other hand, in FIG. 14, a waveform-model conversion unit 202 generates an FPGA RTL operation model 217 based on waveform information 213 and terminal information 214. Hereinafter, differences between this embodiment and the third embodiment are described.

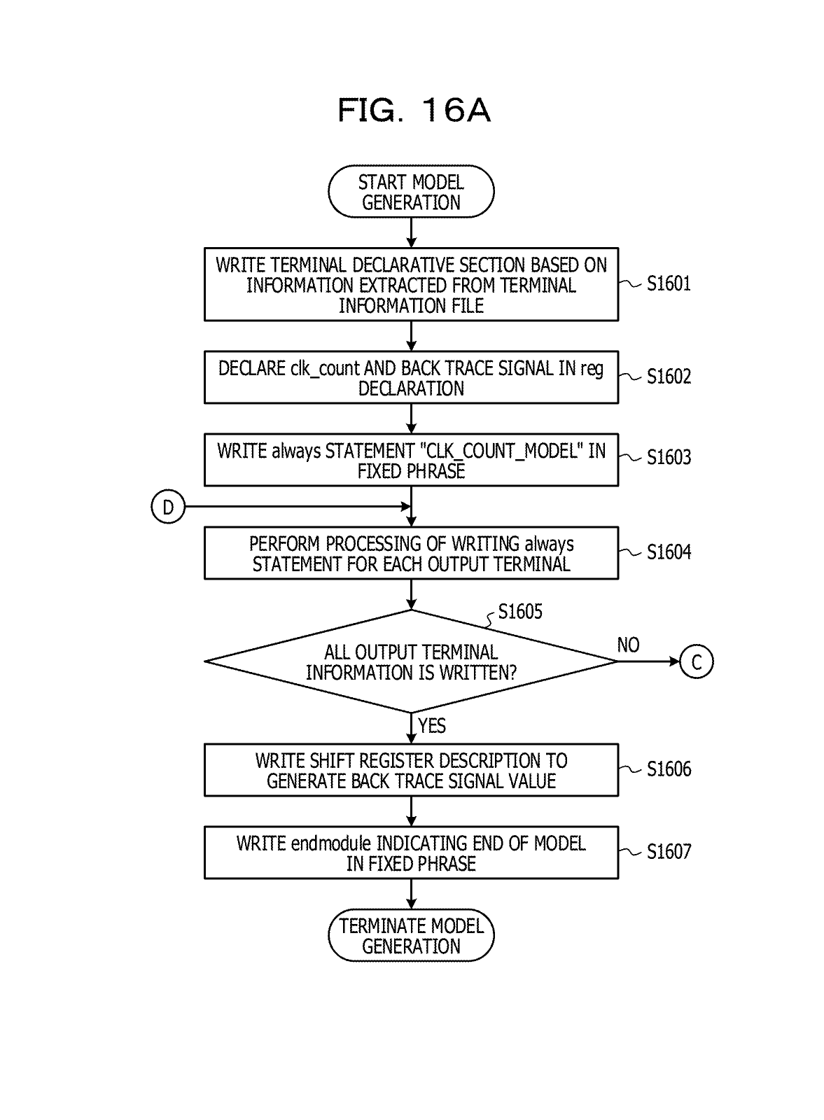

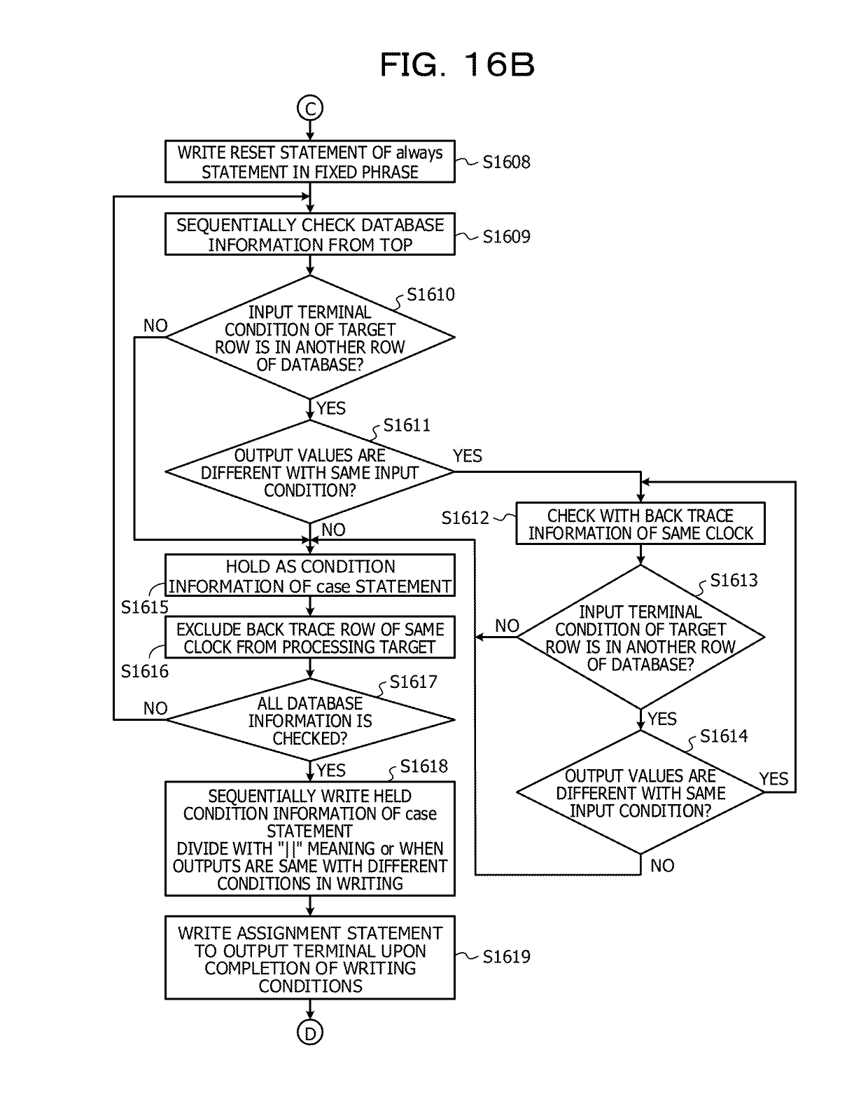

FIG. 15 is a diagram illustrating an example of the FPGA RTL operation model 217 in FIG. 14. FIGS. 16 A and 16B are flowcharts illustrating a processing example of the waveform-model conversion unit 202. Hereinafter, description is given of an example where the waveform-model conversion unit 202 generates the FPGA RTL operation model 217 in FIG. 15.

In Step S1601, the waveform-model conversion unit 202 writes a terminal declarative section 1501 in the FPGA RTL operation model 217 in FIG. 15 based on the information extracted from the file of the terminal information 214 in FIG. 4A.

Next, in Step S1602, the waveform-model conversion unit 202 writes a declaration 1502 of register-type variables clk_count, INDT_1_b1, and INDT_2_b1 in reg declaration, in the FPGA RTL operation model 217 in FIG. 15.

Then, in Step S1603, the waveform-model conversion unit 202 writes an always statement “CLK_COUNT_MODEL” 1503 in a fixed phrase, in the FPGA RTL operation model 217 in FIG. 15. Next, the waveform-model conversion unit 202 writes a reset statement 1504 for the always statement in a fixed phrase, in the FPGA RTL operation model 217 in FIG. 15. Then, the waveform-model conversion unit 202 writes a count-up statement 1505 for the variable clk_count, in the FPGA RTL operation model 217 in FIG. 15.

Thereafter, in Step S1604, the waveform-model conversion unit 202 performs processing of writing the always statement for each output terminal. For example, the waveform-model conversion unit 202 writes an always statement 1506 for the output terminal CARRY, in the FPGA RTL operation model 217 in FIG. 15. Although the description of the output terminal ODT is omitted for ease of explanation in FIG. 15, the description of the output terminal ODT may be generated in the same manner as the description of the output terminal CARRY.

Subsequently, in Step S1605, the waveform-model conversion unit 202 determines whether or not all the output terminal information is written into the FPGA RTL operation model 217. The waveform-model conversion unit 202 advances to Step S1608 when all the information is not written.

In Step S1608, the waveform-model conversion unit 202 writes a reset statement 1507 for the always statement in a fixed phrase, in the FPGA RTL operation model 217 in FIG. 15.

Next, in Step S1609, the waveform-model conversion unit 202 sequentially checks the information in the database 1100 of FIG. 11 from the top.

Then, in Step S1610, the waveform-model conversion unit 202 checks if the condition of the signal values of the input terminals INDT_1 and INDT_2 in the current cycle in a target row of the database 1100 is in a first row of another cycle number of the database 1100. The waveform-model conversion unit 202 advances to Step S1611 when the condition is in the first row of another cycle number, and advances to Step S1615 when the condition is not in the first row of another cycle number.

In Step S1611, the waveform-model conversion unit 202 checks if the signal values of the output terminal CARRY are different, under the same signal value condition of the input terminals INDT_1 and INDT_2, in the target row and the first row of the another cycle number described above, in the database 1100. The waveform-model conversion unit 202 advances to Step S1615 when the signal values are not different, and advances to Step S1612 when the signal values are different.

In Step S1615, the waveform-model conversion unit 202 holds the input terminal condition of the target row in the database 1100 as condition information 1508 or 1510 for a case statement. In this case, the condition information 1508 and 1510 are conditions for the signal values of the input terminals INDT_1 and INDT_2 in the current cycle.

Next, in Step S1616, the waveform-model conversion unit 202 excludes a second row (back trace row) of the clock terminal CLK cycle number having the same input terminal condition described above from the processing target.

Then, in Step S1617, the waveform-model conversion unit 202 checks if all the information in the database 1100 is checked. When all the information is not checked, the waveform-model conversion unit 202 returns to Step S1609 to repeat the above processing.

In Step S1612, the waveform-model conversion unit 202 performs the following check by referring to the back trace information in the second row of the clock terminal CLK cycle number having the same input terminal condition as that described above in the database 1100.

Next, in Step S1613, the waveform-model conversion unit 202 checks if the condition for the signal values INDT_1_b1 and INDT_2_b1 of the input terminals INDT_1 and INDT_2 in the previous cycle in the target row of the database 1100 is in the second row of another cycle number of the database 1100. The waveform-model conversion unit 202 advances to Step S1614 when the condition is in the second row of another cycle number, and advances to Step S1615 when the condition is not in the second row of another cycle number.

In Step S1614, the waveform-model conversion unit 202 checks if the signal values of the output terminal CARRY are different, under the same condition for the signal values INDT_1_b1 and INDT_2_b1, in the target row and the second row of the another cycle number described above, in the database 1100. The waveform-model conversion unit 202 advances to Step S1615 when the signal values are not different, and returns to Step S1612, when the signal values are different, to repeat the processing for the signal values of the input terminals INDT_1 and INDT_2 in the previous cycle.

In Step S1615, the waveform-model conversion unit 202 holds the input terminal condition for the second row of the target cycle number in the database 1100 as condition information 1508 or 1510 for a case statement. In this case, the condition information 1508 and 1510 are conditions for the signal values of the input terminals INDT_1 and INDT_2 in the current cycle and the signal values INDT_1_b1 and INDT_2_b1 thereof in the previous cycle.

In Step S1617, the waveform-model conversion unit 202 advances to Step S1618 when all the information in the database 1100 is checked. In Step S1618, the waveform-model conversion unit 202 sequentially writes the held condition information 1508 and 1510 for the case statement, in the FPGA RTL operation model 217 in FIG. 15. In this writing, when the output terminals have the same signal with the different input terminal conditions, the waveform-model conversion unit 202 uses “||” meaning “or” to mark the boundary therebetween.

Next, in Step S1619, the waveform-model conversion unit 202 writes assignment statements 1509 and 1511 to the output terminal CARRY, upon completion of writing of the condition information 1508 and 1510, in the FPGA RTL operation model 217 in FIG. 15. Then, the waveform-model conversion unit 202 writes an assignment statement 1512 to the default output terminal CARRY.

The condition information 1508 and 1510 and the assignment statements 1509 and 1511 include an operation description of the signal value of the output terminal CARRY, corresponding to the signal values of the input terminals INDT_1 and INDT_2 in the current cycle, and also include an operation description of the signal value of the output terminal CARRY, corresponding to the signal values of the input terminals INDT_1 and INDT_2 in the current cycle and the signal values INDT_1_b1 and INDT_2_b1 thereof in the previous cycle.

Thereafter, the waveform-model conversion unit 202 returns to Step S1604 to repeat the processing for the other output terminal ODT. When the waveform-model conversion unit 202 has written all the output terminal information into the FPGA RTL operation model 217 in Step S1605, the processing advances to Step S1606.

In Step S1606, the waveform-model conversion unit 202 writes a shift register description 1513 for generating back trace signal values INDT_1_b1 and INDT_2_b1, in the FPGA RTL operation model 217 in FIG. 15.

Next, in Step S1607, the waveform-model conversion unit 202 writes information (endmodule) 1514 indicating the end of the FPGA RTL operation model 217 in a fixed phrase, in the FPGA RTL operation model 217 in FIG. 15

Through the above processing, the FPGA RTL operation model 217 in FIG. 15 is completed. In FIG. 2, the processing of the System C operation model generation unit 203 and the processing of the higher order synthesis tool 204 are desired. On the other hand, this embodiment has an advantage that the processing of the System C operation model generation unit 203 and the processing of the higher order synthesis tool 204 do not have to be performed, since the waveform-model conversion unit 202 generates the FPGA RTL operation model 217.

When the waveform information 213 is repetition of a certain pattern or is operated in a regular pattern, the first to third embodiments are effective. On the other hand, when the conditions for the waveform information 213 become complicated, the fourth embodiment is effective. Alternatively, the first embodiment may be applied when there is not much waveform information 213, while the second to fourth embodiments may be applied when there is a lot of waveform information.

The waveform-model conversion unit 202 may also generate an FPGA RTL operation model 217 having an operation description of the signal value of the output terminal, corresponding to the cycle number of the clock terminal signal, as in the case of the first embodiment. The waveform-model conversion unit 202 may also generate an FPGA RTL operation model 217 having the same operation description as those in the second and third embodiment.

### Fifth Embodiment

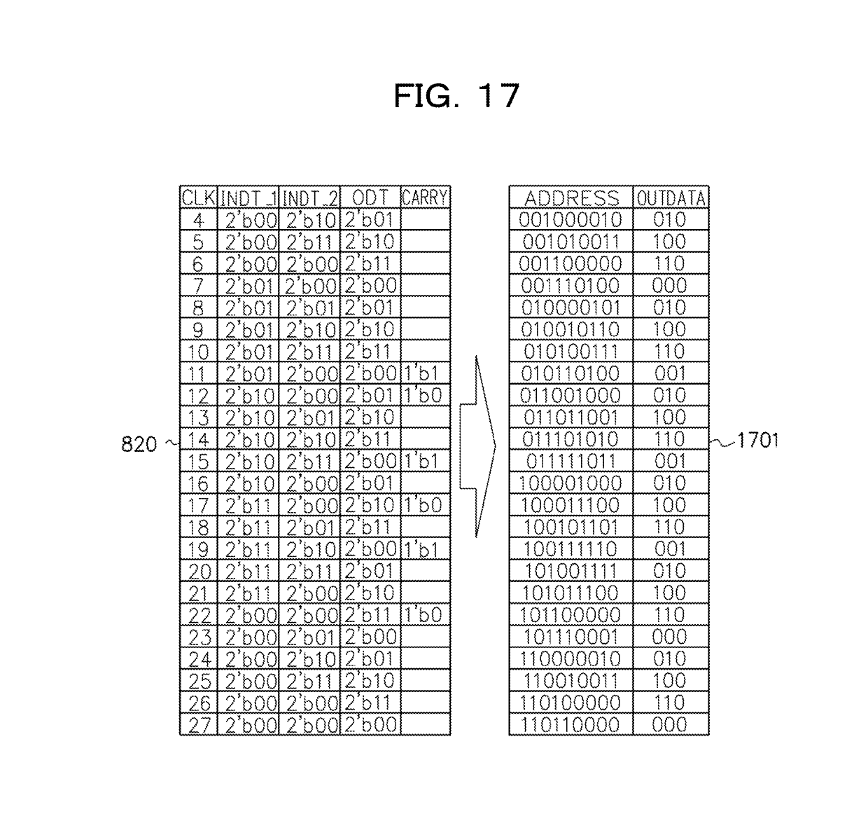

FIG. 17 is a diagram illustrating an example of a database 820 and memory information 1701 according to a fifth embodiment. A waveform-model conversion unit 202 generates the database 820 of signal values of output terminals ODT and CARRY, corresponding to signal values of input terminals INDT_1 and INDT_2, based on waveform information 213, as in the case of the second embodiment. The database 820 represents correspondence relationships between the cycle number of the clock terminal CLK signal, the signal value of the input terminal INDT_1, the signal value of the input terminal INDT_2, the signal value of the output terminal ODT, and the signal value of the output terminal CARRY.

The waveform-model conversion unit 202 generates memory information 1701 based on the database 820 to generate an FPGA RTL operation model 217 that instances a read-only memory (ROM). The memory information 1701 has a correspondence relationship between address ADDRESS of the ROM and data OUTDATA.

The waveform-model conversion unit 202 generates an address ADDRESS of the memory information 1701 based on the cycle number of the clock terminal CLK signal, the signal value of the input terminal INDT_1, and the signal value of the input terminal INDT_2 in the database 820. For example, description is given of a method for generating an address ADDRESS of the memory information 1701 at CLK=4. The cycle number 4 of the clock terminal CLK signal is “00100” when converted to a 5-bit binary number. The signal value of the input terminal INDT_1 is “00” in binary-coded form. The signal value of the input terminal INDT_2 is “10” in binary-coded form. The waveform-model conversion unit 202 generates an address ADDRESS “001000010” by putting together the cycle number “00100” of the clock terminal CLK signal, the signal value “00” of the input terminal INDT_1, and the signal value “10” of the input terminal INDT_2.

The waveform-model conversion unit 202 generates data OUTDATA of the memory information 1701, based on the signal value of the output terminal ODT and the signal value of the output terminal CARRY in the database 820. For example, description is given of a method for generating data OUTDATA of the memory information 1701 at CLK=4. The signal value of the output terminal ODT is “01” in binary-coded form. The initial value of the signal value of the output terminal CARRY is “0” in binary-coded form. The waveform-model conversion unit 202 generates data OUTDATA “010” by putting together the signal value “01” of the output terminal ODT and the signal value “0” of the output terminal CARRY. The waveform-model conversion unit 202 converts all the rows in the database 820 into the memory information 1701.

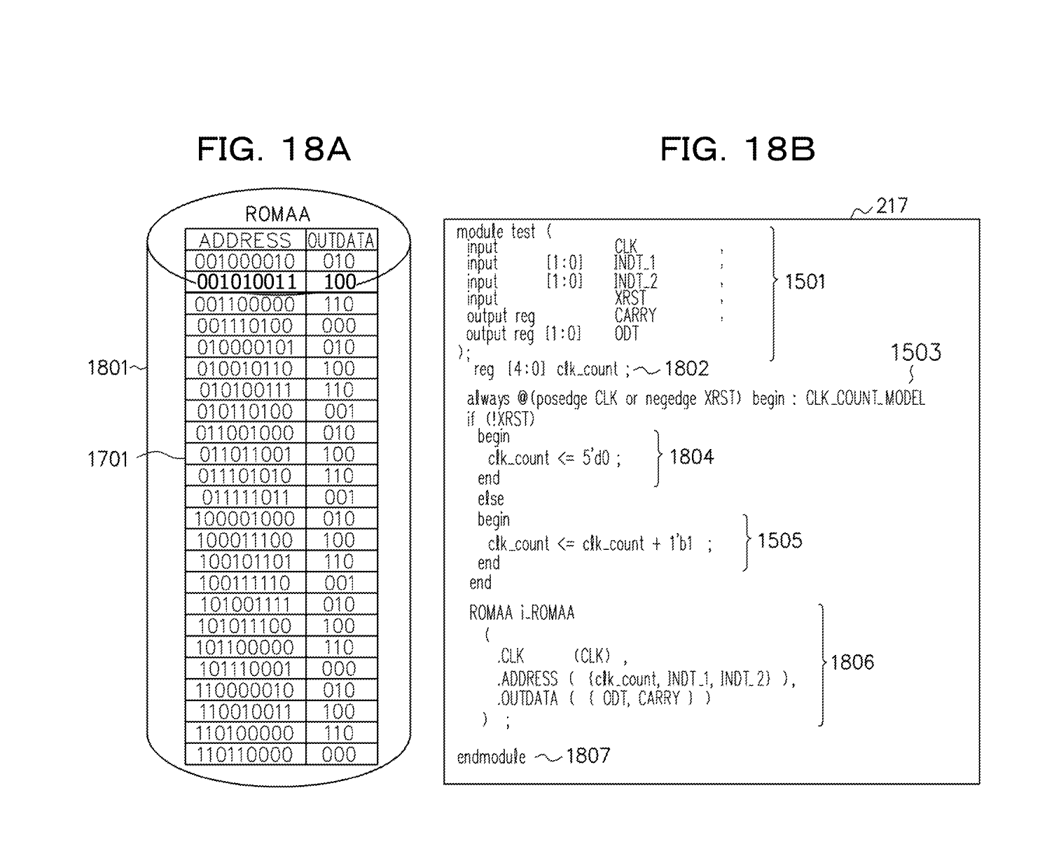

FIG. 18A is a conceptual diagram illustrating a ROM 1801 that stores the memory information 1701 in FIG. 17. FIG. 18B is a diagram illustrating an example of an FPGA RTL operation model 217 that instances the ROM 1801 as a ROMAA. Hereinafter, description is given of a method whereby the waveform-model conversion unit 202 generates the FPGA RTL operation model 217 in FIG. 18B.

First, the waveform-model conversion unit 202 writes a terminal declarative section 1501 in the FPGA RTL operation model 217 in FIG. 18B based on the information extracted from the file of the terminal information 214 in FIG. 4A.

Next, the waveform-model conversion unit 202 writes a declaration 1802 of a register-type variables clk_count in reg declaration, in the FPGA RTL operation model 217 in FIG. 18B. Then, the waveform-model conversion unit 202 writes an always statement “CLK_COUNT_MODEL” 1503 in a fixed phrase, in the FPGA RTL operation model 217 in FIG. 18B.

Thereafter, the waveform-model conversion unit 202 writes a reset statement 1804 for the always statement in a fixed phrase, in the FPGA RTL operation model 217 in FIG. 18B. Subsequently, the waveform-model conversion unit 202 writes a count-up statement 1505 for the variable clk_count, in the FPGA RTL operation model 217 in FIG. 18B.

Next, the waveform-model conversion unit 202 writes instance information 1806 of the ROMAA having the memory information 1701 in the FPGA RTL operation model 217 in FIG. 18B. The address ADDRESS is represented by the cycle number clk_count, the signal value of the input terminal INDT_1, and the signal value of the input terminal INDT_2. The data OUTDATA is represented by the signal value of the output terminal ODT and the signal value of the output terminal CARRY.

Then, the waveform-model conversion unit 202 writes information (endmodule) 1807 indicating the end of the FPGA RTL operation model 217 in a fixed phrase, in the FPGA RTL operation model 217 in FIG. 18B.

Thus, the FPGA RTL operation model 217 is completed. The FPGA RTL operation model 217 operates the ROM that input the address ADDRESS and outputs the data OUTDATA as a logic circuit.

The FPGA RTL operation model 217 is an operation model of a memory expressed by the address ADDRESS and the data OUTDATA. The address ADDRESS is an address based on the cycle number of the clock terminal signal and the signal value of the input terminal. The data DATA is data based on the signal value of the output terminal. The waveform-model conversion unit 202 may also generate the operation model of the memory described above as the HDL operation model 215.

### Sixth Embodiment

In the fifth embodiment, the description is given of the example where the cycle number clk_count and the signal values of the input terminals INDT_1 and INDT_2 are simply used as the address ADDRESS, so that the configuration of the ROM may be easily pictured. However, the larger the cycle number clk_count, the larger the address ADDRESS, leading to increased ROM capacity.

Therefore, in a sixth embodiment, the waveform-model conversion unit 202 also uses a signal value of an input terminal in the previous cycle as a condition to generate information for uniquely determining a signal value of an output terminal based on a signal condition of the input terminal, as in the case of the third embodiment. Thus, an increase in address may be suppressed.

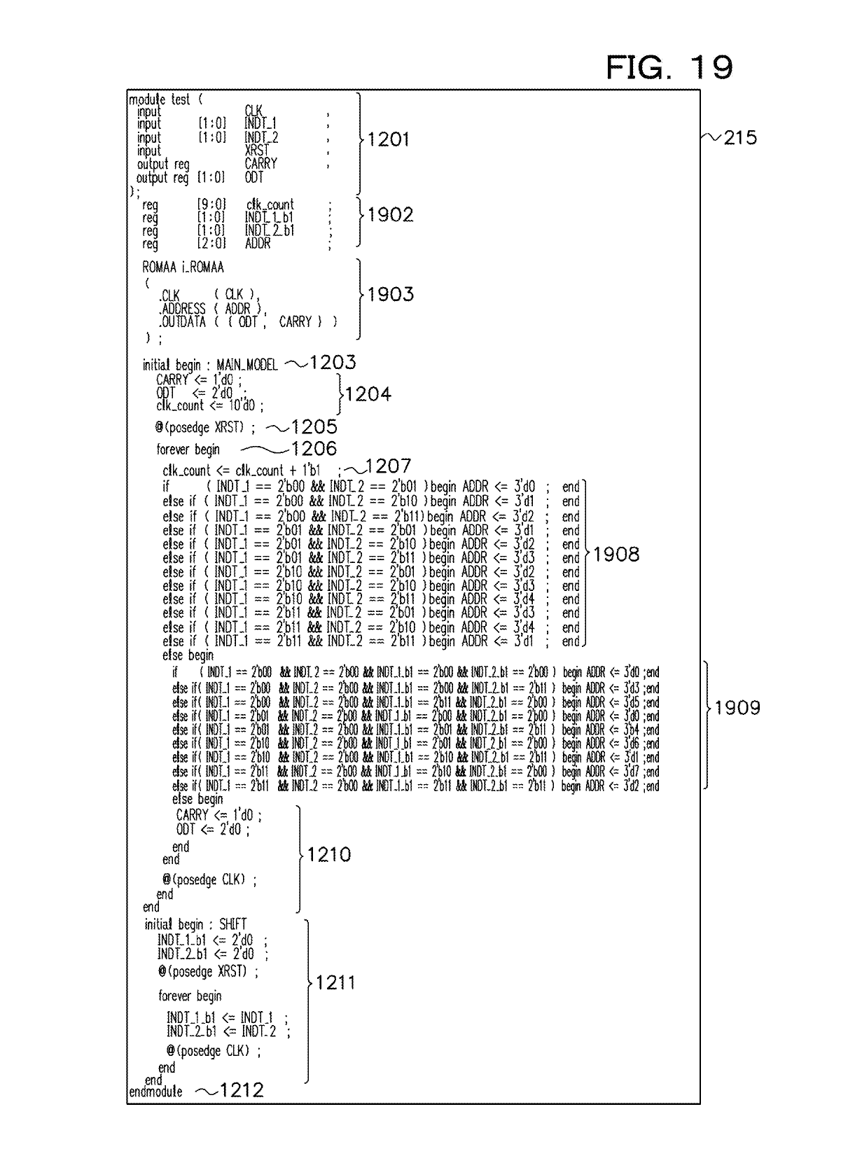

FIG. 19 is a diagram illustrating an example of an HDL operation model 215 that instances a ROM. The waveform-model conversion unit 202 may generate the HDL operation model 215, as in the case of the processing illustrated in the flowchart of FIG. 13, based on the database 1100 in FIG. 11. Hereinafter, description is given of a method whereby the waveform-model conversion unit 202 generates the HDL operation model 215 in FIG. 19.

First, the waveform-model conversion unit 202 writes a terminal declarative section 1201 in the HDL operation model 215 in FIG. 19 based on the information extracted from the file of the terminal information 214 in FIG. 4A.

Next, the waveform-model conversion unit 202 writes a declaration 1902 of variables clk_count, INDT_1_b1, INDT_2_b1, and ADDR in reg declaration, in the HDL operation model 215 in FIG. 19. The variable ADDR represents address.

Then, the waveform-model conversion unit 202 writes instance information 1903 of a ROMAA having memory information in the HDL operation model 215 in FIG. 19. The address ADDRESS is represented by the variable ADDR. The data OUTDATA is represented by the signal value of the output terminal ODT and the signal value of the output terminal CARRY.

Thereafter, the waveform-model conversion unit 202 writes an “initial” statement 1203 in a fixed phrase, in the HDL operation model 215 in FIG. 19. Subsequently, the waveform-model conversion unit 202 writes initialization information 1204 for the output terminals CARRY and ODT and the variable clk_count, in the HDL operation model 215 in FIG. 19, based on the information extracted from the file of the terminal information 214.

Next, the waveform-model conversion unit 202 writes a reset cancellation statement 1205 in a fixed phrase, in the HDL operation model 215 in FIG. 19. Then, the waveform-model conversion unit 202 writes a forever statement 1206 in a fixed phrase, in the HDL operation model 215 in FIG. 19. Thereafter, the waveform-model conversion unit 202 writes a count-up declaration 1207 of the variable clk_count, in the HDL operation model 215 in FIG. 19.

Subsequently, the waveform-model conversion unit 202 writes information 1908 of the variable ADDR, corresponding to the signal values of the input terminals INDT_1 and INDT_2 in the current cycle, in the HDL operation model 215 in FIG. 19. Next, the waveform-model conversion unit 202 writes information 1909 of the variable ADDR, corresponding to the signal values of the input terminals INDT_1 and INDT_2 in the current cycle and the signal values INDT_1_b1 and INDT_2_b1 thereof in the previous cycle, in the HDL operation model 215 in FIG. 19.

Then, the waveform-model conversion unit 202 writes signal values of the output terminals CARRY and ODT in other cases as well as a clock declaration 1210 in the HDL operation model 215 in FIG. 19. Thereafter, the waveform-model conversion unit 202 writes a shift register description 1211 for generating back trace signal values INDT_1_b1 and INDT_2_b1, in the HDL operation model 215 in FIG. 19. Subsequently, the waveform-model conversion unit 202 writes information 1212 indicating the end of the HDL operation model 215 in a fixed phrase, in the HDL operation model 215 in FIG. 19.

Thus, the HDL operation model 215 is completed. The ROM has the advantage of being capable of determining how many FPGA internal resources are desired before the execution of logic synthesis, since the circuit size is determined by the sizes of the address and data.

The HDL operation model 215 is an operation model of a memory expressed by the address ADDRESS and the data OUTDATA. The address ADDRESS is an address based on the signal value of the input terminal in the current cycle and the signal value thereof in the previous cycle. The data DATA is data based on the signal value of the output terminal. The waveform-model conversion unit 202 may also generate the operation model of the memory described above as the FPGA RTL operation model 217.

### Seventh Embodiment

In Step S116 in FIG. 1B, the information processor 100 generates the FPGA RTL operation model 217. In this event, the information processor 100 generates the FPGA RTL operation model 217 based on the waveform information 213. Therefore, the FPGA RTL operation model 217 may not output a desired output signal when an input signal pattern different from the waveform information 213 is inputted thereto.

In a seventh embodiment, a new verification pattern is added to the current waveform information 213 when another verification pattern is desired after the completion of the FPGA RTL operation model 217, and the information processor 100 generates an FPGA RTL operation model 217 based on the updated waveform information 213. Thus, the FPGA RTL operation model 217 may output a proper output signal in response to the input of the new verification pattern. Therefore, the FPGA RTL operation model 217 closer to an actual logic circuit may be generated. Hereinafter, differences between this embodiment and the first to sixth embodiments are described.

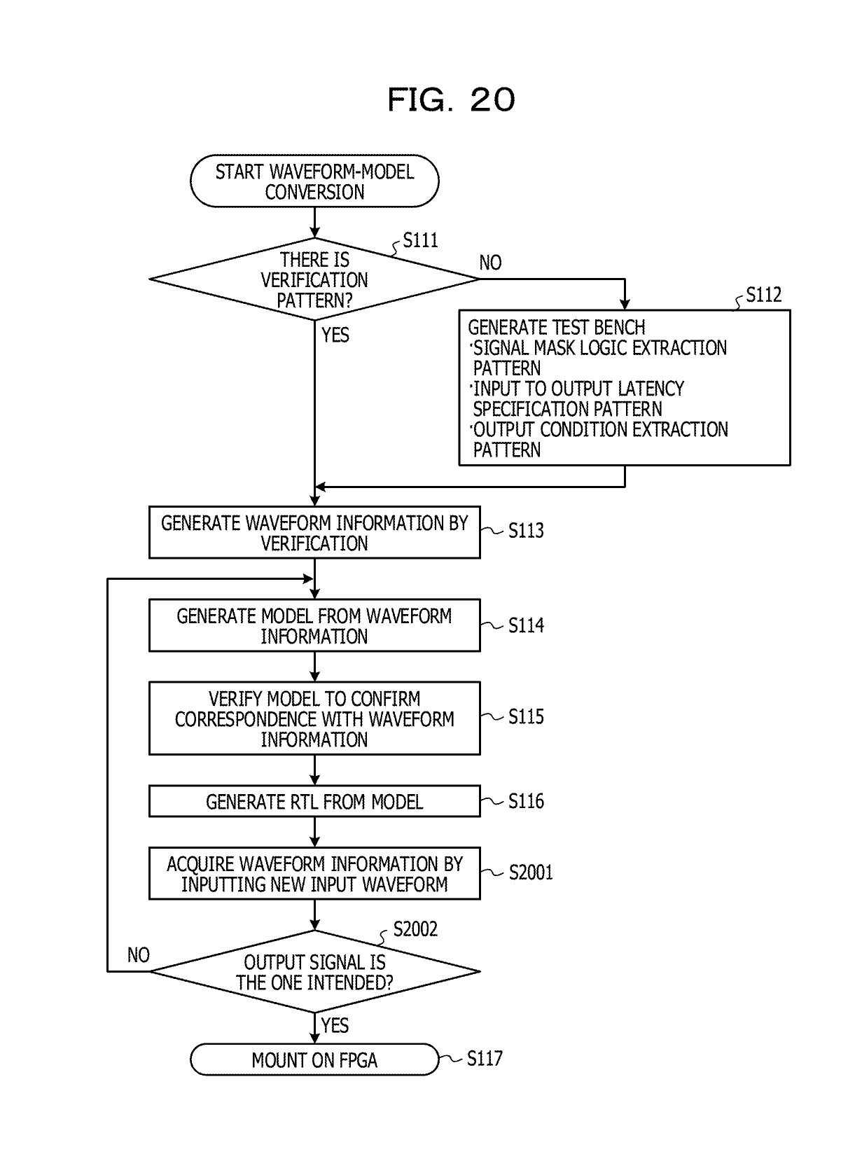

FIG. 20 is a flowchart illustrating an information processing method for the information processor 100 according to the seventh embodiment. FIG. 20 is obtained by adding Steps S2001 and S2002 to FIG. 1B. In Step S2001 after Step S116, the logic verification tool 201 in FIG. 2 inputs a new input signal waveform to the FPGA RTL operation model 217 to acquire output signal waveform information of the FPGA RTL operation model 217.

Next, in Step S2002, the user determines whether or not the output signal is the one intended. When the output signal is the one intended, the user writes logic circuit information based on the FPGA RTL operation model 217 into the FPGA in Step S117.

On the other hand, when the output signal is not the one intended, the user adds input-output waveform information for the new input signal described above to the waveform information 213. Alternatively, the logic verification tool 201 in FIG. 2 may use the verification pattern 212 and the new input signal waveform to update the waveform information 213 based on the ASIC RTL operation model 211. Then, the processing returns to Step S114. In Step S114, the waveform-model conversion unit 202 generates an HDL operation model 215 based on the updated waveform information 213 and the terminal information 214.

Thereafter, in Step S115, the logic verification tool 201 verifies the HDL operation model 215 with the verification pattern 212 and the new input signal waveform to confirm that the waveform information to be generated corresponds to the intended waveform information.

Subsequently, in Step S116, the System C operation model generation unit 203 generates a System C operation model 216 based on the HDL operation model 215. Next, the higher order synthesis tool 204 generates an FPGA RTL operation model 217 based on the System C operation model 216. The user verifies the generated FPGA RTL operation model 217, and writes logic circuit information based on the FPGA RTL operation model 217 into the FPGA.

According to this embodiment, the information processor 100 may update the FPGA RTL operation model 217 by adding a new verification pattern to the current waveform information 213 when another verification pattern is desired after the completion of the FPGA RTL operation model 217. Thus, the FPGA RTL operation model 217 closer to the actual logic circuit may be generated.

According to the first to seventh embodiments, the information processor 100 may generate the FPGA RTL operation model 217 based on the ASIC RTL operation model 211. Thus, the design period for the logic circuit operation model may be shortened. Also, manual redesign work for the FPGA RTL operation model 217 is no longer desired, and thus the FPGA RTL operation model 217 may be generated according to the items wished to be evaluated in a period when the evaluation is wished to be performed. Therefore, the design period may be shortened. The FPGA RTL operation model 217 may realize a functionally equivalent circuit in accordance with the evaluation items. Thus, the FPGA RTL operation model 217 may be applied to the codesign of hardware design and software verification. Although the description is given of the example of generating the FPGA RTL operation model 217, as an example, another operation model may be generated.

The above embodiments are all merely examples of embodiments and the technical scope of the embodiments may not be construed as limited to those described above. For example, the embodiments may be implemented in various other ways without departing from the technical spirit or scope thereof.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An operation model generator comprising:
one or more memories; and
one or more processors coupled to the one or more memories and the one or more processors configured to
perform acquisition of signal information indicating signal values of an input signal and an output signal in a first register transfer level operation model of a logic circuit, and
generate a hardware description language operation model of the logic circuit in accordance with the acquired signal information.

2. The operation model generator according to claim 1, wherein
the acquisition is executed by verifying the first register transfer level operation model in accordance with a verification pattern.

3. The operation model generator according to claim 1, wherein
the processor configured to generate a second register transfer level operation model based on the hardware description language operation model.

4. The operation model generator according to claim 3, wherein
the first register transfer level operation model is an ASIC register transfer level operation model, and
the second register transfer level operation model is an FPGA register transfer level operation model.

5. The operation model generator according to claim 1, wherein
the signal information includes signal values of input signals to one or more input terminals and of output signals from one or more output terminals.

6. The operation model generator according to claim 5, wherein
the hardware description language operation model includes an operation description of a first signal value of a first output terminal, the first signal value corresponding to a cycle of a clock terminal signal in the first RTL operation model.

7. The operation model generator according to claim 5, wherein
the hardware description language operation model includes an operation description of a first signal value of a first output terminal, the first signal value corresponding to a signal value of a first input terminal.

8. The operation model generator according to claim 5, wherein
the hardware description language operation model includes an operation description of a first signal value of a first output terminal, the first signal value corresponding to both a second signal value of a first input terminal in the current cycle and a third signal value of the first input terminal in the previous cycle.

9. The operation model generator according to claim 5, wherein
the hardware description language operation model is an operation model of a memory, the operation model being expressed by using an address and data,
the address is an address based on one or more signal values of the one or more input terminals, and
the data is data based on one or more signal values of the one or more output terminals.

10. The operation model generator according to claim 5, wherein
the hardware description language operation model is an operation model of a memory, the operation model being expressed by using an address and data,
the address is an address based on both a cycle number of a clock terminal signal and a signal value of a first input terminal, and
the data is data based on a signal value of a first output terminal.

11. The operation model generator according to claim 5, wherein
the hardware description language operation model is an operation model of a memory, the operation model being expressed by using an address and data,
the address is an address based on a signal value of a first input terminal in the current cycle and a signal value of the first input terminal in the previous cycle, and
the data is data based on a signal value of a first output terminal.

12. A computer-implemented operation model generation method comprising:
acquiring signal information indicating signal values of an input signal and an output signal in a first register transfer level operation model of a logic circuit; and
generating a hardware description language operation model of the logic circuit in accordance with the acquired signal information.

13. The operation model generation method according to claim 12, wherein
the acquiring is executed by verifying the first register transfer level operation model in accordance with a verification pattern.

14. The operation model generation method according to claim 12, further comprising:
generating a second register transfer level operation model based on the hardware description language operation model.

15. The operation model generation method according to claim 14, wherein
the first register transfer level operation model is an ASIC register transfer level operation model, and
the second register transfer level operation model is an FPGA register transfer level operation model.

16. A non-transitory computer-readable medium storing instructions executable by one or more computer, the instructions comprising:
one or more instructions for acquiring signal information indicating signal values of an input signal and an output signal in a first register transfer level operation model of a logic circuit; and
one or more instructions for generating a hardware description language operation model of the logic circuit in accordance with the acquired signal information.
